(19) United States
(12) Patent Application Publication
(10) Pub. No.: US 2026/0187594 A1
(43) Pub. Date: Jul. 2, 2026

(54) ISSUE TRACKING PLATFORM WITH A GENERATIVE SERVICE FOR CREATING NEW ISSUES

(71) Applicant: Atlassian Pty Ltd., Sydney (AU)

(72) Inventors: Qinlong Luo, Alpharetta, GA (US); Geunbae Lee, Gilbert, AZ (US); Timothy Pike, San Diego, CA (US); Anne Reints, Peachtree City, GA (US); Eric Kang, San Diego, CA (US); Michael Johnson, Aurora, CO (US); Yingjie Ma, Orange, CA (US); Fan Jiang, Mountain View, CA (US); Akhilesh Kaza, Sammamish, WA (US)

(21) Appl. No.: 19/004,441

(22) Filed: Dec. 29, 2024

(51) Int. Cl. G06Q 10/10; G06F 3/0482; G06F 16/334

(52) U.S. Cl. CPC G06Q 10/103; G06F 3/0482; G06F 16/334

(57) ABSTRACT

Embodiments described herein relate to systems and methods for generating a set of issues for an issue tracking platform. The system can generate a user account at the issue tracking platform, and cause display of an intake interface on a client device. The system can analyze the user input received at the intake interface to determine a project type classifier and execute a search at the issue tracking platform to identify issues managed by the issue tracking platform. The system can cause generation of a prompt that includes predetermined prompt language selected based on the project classifier, and data extracted from the set of issues. The system can analyze a generative response to identify a project definition and one or more issues and cause generation of a project comprising the one or more issues hierarchically related to the project.

### TECHNICAL FIELD

Embodiments described herein relate to multi-tenant services of collaborative work environments and, in particular, to systems and methods for operating a generative answer interface that produces generative content based on user specific inputs.

### BACKGROUND

An organization can employ software tools to assist with technical problems and interruptions in technical service. Typically, an issue tracking platform or similar software platform may be used to track and manage technical problems logged by system users. However, the information contained in a large system may be difficult to access in an efficient interface and information that resides in disparate locations in the system or that is entered over a period of time may be difficult to compile and access when managing a large quantity of issues. The systems and techniques described herein may be used to provide improved content generation in a way that mitigates technical deficiencies of some traditional interfaces and systems.

### SUMMARY

Embodiments described herein are directed to methods for generating a set of issues for an issue tracking platform. The methods can include generating a user account at the issue tracking platform in response to a request from a client device and causing display of an intake interface on the client device in response to generating the user account. The methods can include analyzing the user input to determine a project type classifier in response to receiving user input at the intake interface and executing a search at the issue tracking platform to identify a set of issues managed by the issue tracking platform. The search can include search parameters generated using data extracted from analyzing the user input. The methods can include causing generation of a prompt that includes predetermined prompt language selected based on the project classifier and data extracted from the set of issues. In response to receiving a generative response from a generative output engine, the methods can include analyzing the generative response to identify a first portion of the generative response corresponding to a project definition and a second portion of the generative response corresponding to one or more issues. The methods can include causing generation of a project including the one or more issues hierarchically related to the project and causing display of a project interface comprising one or more graphical objects each corresponding to an issue of the one or more issues.

Embodiments described herein are also directed to methods for generating example issues for an issue tracking platform. The methods include receiving a request to generate a user account at the issue tracking platform, and in response to receiving the request, causing display of an intake interface comprising a first set of selectable options. The methods include causing display of a second set of selectable options at the intake interface in response to detecting a selection of a first selectable option from the first set of selectable options. The second set of selectable options can be determined using the first selectable option and a defined set of parameters. In response to detecting a selection of a second selectable option from the second set of selectable options, the methods include executing a formatted search request for the issue tracking platform. The formatted search request can be generated using data determined from the first selectable option and the second selectable option. Subsequent to receiving a set of issues in response to executing the formatted search request the methods can include causing generation of a prompt including issue data extracted from the set of issues, and prompt text including a request to create issue data for one or more new issues. The methods include providing the prompt to a generative output engine and receiving a generative response from a generative output engine. The generative response can be produced by the generative output engine in response to the prompt. The methods can include analyzing the generative response to identify one or more issue data sets and in response to identifying the one or more issue data sets, causing creation of a project including using the one or more issue data sets. The methods include causing display of a project interface comprising issue objects based on the one or more issue data sets.

Embodiments are further directed to an issue tracking platform backend application operating on one or more servers. The issue tracking platform backend application is operably coupled to a frontend application operating on a client device. The issue tracking platform backend application is configured to generate a user account at the issue tracking platform in response to a request from a client device, and cause display of an intake interface on the client device in response to generating the user account. The issue tracking backend application can be configured to analyze the user input to determine a project type classifier in response to receiving user input at the intake interface and execute a search at the issue tracking platform to identify a set of issues managed by the issue tracking platform. The search includes search parameters generated using data extracted from analyzing the user input. The issue tracking platform backend can be configured to cause generation of a prompt including predetermined prompt language selected based on the project classifier, and data extracted from the set of issues. In response to receiving a generative response from a generative output engine, the issue tracking platform backend can be configured to analyze the generative response to identify a first portion of data corresponding to a project definition and a second portion of data corresponding to one or more issues, generate a project comprising the one or more issues hierarchically related to the project, and cause display of a project interface comprising one or more graphical objects each corresponding to an issue of the one or more issues.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a system, such as described herein that can include and/or may receive input from a generative output engine.

FIG. 2 depicts an example system for using a generative output engine to generate a set of issues as part of an account activation at an issue tracking platform.

FIG. 3A depicts a simplified diagram of a system, such as described herein that can include and/or may receive input from a generative output engine.

FIG. 3B depicts a functional system diagram of a system that can be used to implement a multiplatform prompt management service.

FIG. 4A depicts a simplified system diagram and data processing pipeline.

FIG. 4B depicts a system providing multiplatform prompt management as a service.

FIG. 5 depicts an example process for using a generative output engine to generate a new set of issues as part of an account activation process, as described herein.

FIG. 6 depicts an example intake interface for generating a new set of issues at an issue tracking platform.

FIGS. 7A-7C depict an example intake interface for generating a new set of issues at an issue tracking platform.

FIG. 8 depicts an example intake interface for generating a new set of issues at an issue tracking platform.

FIG. 9 depicts an example project interface including a new set of issues generated using a generative output engine as part of an account activation process.

FIG. 10 depicts an example issue view interface for an issue generated using a generative output engine, as described herein.

FIG. 11 depicts an example project interface including a new set of issues generated using a generative output engine as part of an account activation process.

FIG. 12 shows a sample electrical block diagram of an electronic device.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiment described herein are related to systems and methods for generating a new set of issues at an issue tracking platform as part of an account activation process for a user of the issue tracking platform. The system and methods can be configured to collect information from the user and use that information to generate a new set of issues. For example, the system and methods may include collecting information about the user's role in an organization, the user's projected use of the system, and/or other information related to the type of projects that the user will be participating in. This information can be used to generate a search request to find current issues and/or projects managed by the issue tracking platform that are similar to the types of projects and issues that the user will be working on. Issue data from these issues along with information collected from the user can be used to generate a prompt for a generative output engine. The prompt can be configured to cause the generative output engine to create data defining a project and one or more new issues. The output from the generative output engine can be analyzed and used to generate the project and new issues at the issue tracking platform. The system and methods can include displaying a project interface in the issue tracking platform that includes graphical objects corresponding to the new issues generated by the generative output engine and created at the issue tracking platform. Accordingly, intake information for a specific user can be used to create one or more projects having a tailored set of issues for each user as part of an intake process.

A project can be a container configured by the issue tracking platform that organizes and tracks issues or other tasks. For example, a project can be a set of hierarchically related issues that can be used to represent a product, project, or service. In some cases, projects have three elements including issues, user accounts, and workflow. A user can assign issues to other users and create flexible workflows to move the project along its lifecycle. Project details can be configured using parameters including project permissions, issue types, workflows, and/or other relevant fields.

An issue is a data structure that defines work to be completed or an action that needs to be taken. Issues can represent many different things, such as a project task, a bug request, a helpdesk ticket, a leave request form, an incident, a service request, and so on. Issues are classified by type and can have defined hierarchy with respect to other issues and/or projects. For example, a project can have a set of issues that depend from and define the project. Issues are data structures that store data, define tasks, can trigger events and be used by the issue tracking platform to perform other actions. For example, an issue may have a title, description, assignee(s), defined hierarchical relationships with other issues and/or projects, defined workflows, trigger automations, and so on. A workflow may define a series of states that the issue or task must traverse before being completed. The system may also track user interaction events, issue state transitions, and other events that occur over the lifecycle of the issue, which may be indexed and searchable by the system.

Typical account generation processes may include setting up user credentials, authorizing a user for specific software services, and providing a user with tutorials or generalized resources that provide examples of how to operate the software services. These generalized resources are often focused on teaching how the various software tools function and providing example uses of features of the software. The generalized resources are usually not tailored to a particular user and at best target specific use cases (e.g., based on a user's role in the organization). Once the generalized resources have been viewed, a user of the issue tracking platform can use the knowledge to perform their work, however the user typically has to start from scratch to create projects and issues in the issue tracking platform. In highly integrated and complex issue tracking platforms (e.g., issue tracking platforms that interface with multiple other software platforms and services and include related issues, automation of specific tasks and issues and issue dependencies), projects or issues created by a new user may be improperly formatted and/or inefficiently interoperate with current issues of the issue tracking platform.

The systems and methods provided herein can automatically create a new project(s) and/or issues for a user as part of an account activation process, and use data obtained from current issues to increase interoperability of the new issues with the issue tracking platform. Further, these new projects and/or issues can be tailored to provide a user with both one or more new issues that are specific to their role and/or project types while also demonstrating features of the issue tracking platform that are specifically tailored to each user.

In some cases, the account activation process includes generating a user account at the issue tracking platform. As part of the account generation process, a user may establish login credentials and authenticate/validate that the login credentials grant access to one or more services/features provided by the issue tracking platform. In some cases, a user may have established login credentials, for example for other software services, and may authenticate/validate that their login credentials grant access to service/features of the issue tracking platform. In some cases, a user account may be a new user account in an enterprise that has an established license granting access to software services. In these cases, an enterprise domain (enterprise account) associated with the new user account, may already have other users established at one or more platforms and accessing software services.

In response to generating/authenticating the user account, the issue tracking platform can cause display of an intake interface on a client device (e.g., a device used to establish the user account). The intake interface can be configured to obtain information relating to a particular user's use of the issue tracking platform and be configured to receive user input to the intake interface. In some cases, the intake interface may include a series of interfaces that are used to collect user input that is in turn used to generate the new set of issues. A first interface can be configured to receive user input for a first type of information and the user input to the first interface may be used to select a next interface that is displayed as part of the series of interfaces. For example, a first user interface may be configured to determine a user role and display selectable objects each corresponding to different role types configured at the issue tracking platform. In response to user input selecting a graphical object corresponding to a particular role type, the issue tracking platform may determine a second user interface that is configured to determine a second type of information. For example, the second user interface may be configured to receive user input to determine a project type classifier.

In some cases, the intake interface can include a text-based input field and a user can input text-based descriptions, which can be used to collect information about a particular user and/or project type classifiers for that user. In some cases, the text-based interface may generate prompts for the user, which may be pre-defined questions and/or questions generated using a generative output engine, as described herein. The intake interface can receive user-input at the text-based input filed, in response to a prompt, and associate the user-inputs with the prompt. In some cases, the user input, prompt and/or other data (e.g., data retrieved using the user account) may be input to a generative output engine with instructions to provide additional prompts for collecting additional data. In these cases, the intake interface may include a series of prompts, some or all of which are generated based on outputs from a generative output engine.

User input to the intake interface can be used to generate a search request for identifying similar projects and/or issues at the issue tracking platform, and the identified projects and/or issues can be used as part of a prompt that is input to a generative output engine. The user input can be analyzed and data extracted from the user input can be used to generate search parameters for the search request. The data analysis and search parameters can be configured to identify projects and/or issues at the issue tracking platform that are similar to projects or issues that will be utilized by the user establishing the user account. For example, the data analysis can extract the user's assigned role, determine a project type classifier, and/or other information about a user and generate structured search parameters using this information.

The issue tracking platform can execute the search request to identify a set of issues and/or projects that are managed by the issue tracking platform. The system and methods can include analyzing and/or extracting issue data from the set of issues, which can be included in a prompt as example issue data. For example, the systems and methods can include parsing issue data associated with each issue to extract specific fields for each issue such as an issue title, an issue description, a project workflow, hierarchical relationships, and so on. The extracted issue data can include issue data for complete and/or pending projects and include data related to timing and/or completions of various tasks associated with an issue. For example, the data may include defined project deadlines (e.g., service level agreements (SLA)), actual completion deadlines, changes in status of a task or issue and so on.

The issue tracking platform can generate a prompt that includes the extracted data from the set of issues and predetermined prompt language providing instructions to a generative output engine. The issue tracking platform can condition and submit the prompt to a generative output engine, as described herein, and receive a generative response. The issue tracking platform can analyze the generative response to identify data from the output that can be used to create a new project and/or new issues for the user account at the issue tracking platform. For example, in some cases the prompt can include a command/instructions to generate new project and issue data and output the data according to a particular structed data format (e.g., JSON format). The issue tracking platform can be configured to analyze the structured data format, extract data that will be used to create a new project and/or issues and cause the new project and/or issues to be generated at the issue tracking platform.

In response to generating the new project and/or issues, the issue tracking platform can cause display of a project interface on the client device authenticated with respect to the user account. The project interface can include graphical objects that correspond to the newly created issues and display issue data, hierarchical dependencies, due dates, status and/or other information about each issue and/or an associated project. Accordingly, the account activation can include generating a preliminary project and/or set of issues that are specific to the particular user account and provide examples of features of the issue tracking platform. These newly created issues can be issues that fall within the job duties of the user and are not merely demonstrative examples. In this regard the account activation project can cause one or more new issues to be automatically generated for a particular user account without needing a particular user to manually create the issues at the issue tracking platform.

The foregoing embodiments are not exhaustive of the manners by which automatically generated content can be used in multi-platform computing environments, such as those that include more than one collaboration tool (e.g., an issue tracking platform). More generally and broadly, embodiments described herein include systems configured to automatically generate content within environments defined by software platforms. The content can be directly consumed by users of those software platforms or indirectly consumed by users of those software platforms (e.g., formatting of existing content, causing existing systems to perform particular tasks or sequences of tasks, orchestrate complex requests to aggregate information across multiple documents or platforms, and so on) or can integrate two or more software platforms together (e.g., reformatting or recasting user generated content from one platform into a form or format suitable for input to another platform).

### SCALABLE NETWORK ARCHITECTURE FOR AUTOMATIC CONTENT GENERATION

More specifically, systems and methods described herein can leverage a scalable network architecture that includes an input request queue, a normalization (and/or redaction) preconditioning processing pipeline, an optional secondary request queue, and a set of one or more purpose-configured large language model instances (LLMs) and/or other trained classifiers or natural language processors.

Collectively, such engines or natural language processors may be referred to herein as “generative output engines.” A system incorporating a generative output engine can be referred to as a “generative output system” or a “generative output platform.” Broadly, the term “generative output engine” may be used to refer to any combination of computing resources that cooperate to instantiate an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof.

The string prompt (or “input prompt” or simply “prompt”) received as input by a generative output engine can be any suitably formatted string of characters, in any natural language or text encoding. In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt may include letters, numbers, whitespace, punctuation, and in some cases formatting. Similarly, the generative response of a generative output engine as described herein can be formatted/encoded according to any suitable encoding (e.g., ISO, Unicode, ASCII as examples). In these embodiments, a user may provide input to a software platform coupled to a network architecture as described herein. The user input may be in the form of interaction with a graphical user interface affordance (e.g., button or other UI element), or may be in the form of plain text. In some cases, the user input may be provided as typed string input provided to a command prompt triggered by a preceding user input.

For example, the user may engage with a button in a UI that causes a command prompt input box to be rendered, into which the user can begin typing a command. In other cases, the user may position a cursor within an editable text field and the user may type a character or trigger sequence of characters that cause a command-receptive user interface element to be rendered. As one example, a text editor may support slash commands-after the user types a slash character, any text input after the slash character can be considered as a command to instruct the underlying system to perform a task.

Regardless of how a software platform user interface is instrumented to receive user input, the user may provide an input that includes a string of text including a natural language request or instruction (e.g., a prompt). The prompt may be provided as input to an input queue including other requests from other users or other software platforms. Once the prompt is popped from the queue, it may be normalized and/or preconditioned by a preconditioning service.

The preconditioning service can, without limitation: append additional context to the user's raw input; may insert the user's raw input into a template prompt selected from a set of prompts; replace ambiguous references in the user's input with specific references (e.g., replace user-directed pronouns with user IDs, replace @mentions with user IDs, and so on); correct spelling or grammar; translate the user input to another language; or other operations. Thereafter, optionally, the modified/supplemented/hydrated user input can be provided as input to a secondary queue that meters and orders requests from one or more software platforms to a generative output system, such as described herein. The generative output system receives, as input, a modified prompt and provides a continuation of that prompt as output which can be directed to an appropriate recipient, such as the graphical user interface operated by the user that initiated the request or such as a separate platform. Many configurations and constructions are possible.

### LARGE LANGUAGE MODELS

An example of a generative output engine of a generative output system as described herein may be a large language model (LLM). Generally, an LLM is a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the like).

More simply, an LLM is configured to determine what word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phase referencing words, characters, numbers, whitespace, formatting, and the like), an LLM is trained against as large of a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. Generally, an LLM may be trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist. For example, the grammatically incomplete prompt of “can a computer” invites completion, but also represents an initial phrase that can begin a near limitless number of probabilistically reasonable next words, phrases, punctuation and whitespace. A generative output engine may not provide a contextually interesting or useful response to such an input prompt, effectively choosing a continuation at random from a set of generated continuations of the grammatically incomplete prompt.

By contrast, a narrower prompt that invites continuation may be “can a computer supplied with a 30 W power supply consume 60 W of power?” A large number of possible correct phrasings of a continuation of this example prompt exist, but the number is significantly smaller than the preceding example, and a suitable continuation may be selected or generated using a number of techniques. In many cases, a continuation of an input prompt may be referred to more generally as “generated text” or “generated output” provided by a generative output engine as described herein.

Generally, many written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation.

In addition, because punctuation and whitespace can serve as a portion of training data, generated output of an LLM can be expected to be grammatically and syntactically correct, as well as being punctuated appropriately. As a result, generated output can take many suitable forms and styles, if appropriate in respect of an input prompt.

Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt.

For example, a prompt of “what is the syntax for a while loop in C and how does it work” may be continued by an LLM by providing, in addition to an explanation in natural language, a C++compliant example of a while loop pattern. In some cases, the continuation/generative output may include format tags/keys such that when the output is rendered in a user interface, the example C++ code that forms a part of the response is presented with appropriate syntax highlighting and formatting.

As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM generated output may insert cross-links to other content, such as other documents, other software platforms, or external resources such as websites.

In yet further examples, an LLM generated output can convert static content to dynamic content. In one example, a user-generated document can include a string that contextually references another software platform. For example, a documentation platform document may include the string “this document corresponds to project ID 123456, status of which is pending.” In this example, a suitable LLM prompt may be provided that causes the LLM to determine an association between the documentation platform and a project management platform based on the reference to “project ID 123456.”

In response to this recognized context, the LLM can wrap the substring “project ID 123456” in anchor tags with an embedded URL in HTML-compliant syntax that links directly to project 123456 in the project management platform, such as: “<a href='https://example link/123456>project 123456</a>”.

In addition, the LLM may be configured to replace the substring “pending” with a real-time updating token associated with an API call to the project management system. In this manner, the LLM converts a static string within the document management system into richer content that facilitates convenient and automatic cross-linking between software products, which may result in additional downstream positive effects on performance of indexing and search systems.

In further embodiments, the LLM may be configured to generate as a portion of the same generated output a body of an API call to the project management system that creates a link back or other association to the documentation platform. In this manner, the LLM facilities bidirectional content enrichment by adding links to each software platform.

More generally, a continuation produced as output by an LLM can include not only text, source code, pseudocode, structured data, and/or cross-links to other platforms, but it also may be formatted in a manner that includes titles, emphasis, paragraph breaks, section breaks, code sections, quote sections, cross-links to external resources, inline images, graphics, table-backed graphics, and so on.

In yet further examples, static data may be generated and/or formatted in a particular manner in a generative output. For example, a valid generative output can include JSON-formatted data, XML-formatted data, HTML-formatted data, markdown table formatted data, comma-separated value data, tab-separated value data, or any other suitable data structuring defined by a data serialization format.

### TRANSFORMER ARCHITECTURE

In many constructions, an LLM may be implemented with a transformer architecture. In other cases, traditional encoder/decoder models may be appropriate. In transformer topologies, a suitable self-attention or intra-attention mechanism may be used to inform both training and generative output. A number of different attention mechanisms, including self-attention mechanisms, may be suitable.

In sum, in response to an input prompt that at least contextually invites continuation, a transformer-architected LLM may provide probabilistic, generated, output informed by one or more self-attention signals. Even still, the LLM or a system coupled to an output thereof may be required to select one of many possible generated outputs/continuations.

In some cases, continuations may be misaligned in respect of conventional ethics. For example, a continuation of a prompt requesting information to build a weapon may be inappropriate. Similarly, a continuation of a prompt requesting to write code that exploits a vulnerability in software may be inappropriate. Similarly, a continuation requesting drafting of libelous content in respect of a real person may be inappropriate. In more innocuous cases, continuations of an LLM may adopt an inappropriate tone or may include offensive language.

In view of the foregoing, more generally, a trained LLM may provide output that continues an input prompt, but in some cases, that output may be inappropriate. To account for these and other limitations of source-agnostic trained LLMs, fine tuning may be performed to align output of the LLM with values and standards appropriate to a particular use case. In many cases, reinforcement training may be used. In particular, output of an untuned LLM can be provided to a human reviewer for evaluation.

The human reviewer can provide feedback to inform further training of the LLM, such as by filling out a brief survey indicating whether a particular generated output: suitably continues the input prompt; contains offensive language or tone; provides a continuation misaligned with typical human values; and so on.

This reinforcement training by human feedback can reinforce high quality, tone neutral, continuations provided by the LLM (e.g., positive feedback corresponds to positive reward) while simultaneously disincentivizing the LLM to produce offensive continuations (e.g., negative feedback corresponds to negative reward). In this manner, an LLM can be fine-tuned to preferentially produce desirable, inoffensive, generative output which, as noted above, can be in the form of natural language and/or source code.

### GENERATIVE OUTPUT ENGINES & GENERATIVE OUTPUT SYSTEMS

Independent of training and/or configuration of one or more underlying engines (typically instantiated as software), it may be appreciated that generally and broadly, a generative output system as described herein can include a physical processor or an allocation of the capacity thereof (shared with other processes, such as operating system processes and the like), a physical memory or an allocation thereof, and a network interface. The physical memory can include datastores, working memory portions, storage portions, and the like. Storage portions of the memory can include executable instructions that, when executed by the processor, cause the processor to (with assistance of working memory) instantiate an instance of a generative output application, also referred to herein as a generative output service.

The generative output application can be configured to expose one or more API endpoint, such as for configuration or for receiving input prompts. The generative output application can be further configured to provide generated text output to one or more subscribers or API clients. Many suitable interfaces can be configured to provide input to and to receive output from a generative output application, as described herein.

For simplicity of description, the embodiments that follow reference generative output engines and generative output applications configured to exchange structured data with one or more clients, such as the input and output queues described above. The structured data can be formatted according to any suitable format, such as JSON or XML. The structured data can include attributes or key-value pairs that identify or correspond to subparts of a single response from the generative output engine.

For example, a request to the generative output engine from a client can include attribute fields such as, but not limited to: requester client ID; requester authentication tokens or other credentials; requester authorization tokens or other credentials; requester username; requester tenant ID or credentials; API key(s) for access to the generative output engine; request timestamp; generative output generation time; request prompt; string format form generated output; response types requested (e.g., paragraph, numeric, or the like); callback functions or addresses; generative engine ID; data fields; supplemental content; reference corpuses (e.g., additional training or contextual information/data) and so on. A simple example request may be JSON formatted, and may be:

```
{
      “prompt” : “Generate five words of placeholder text in the
English language.”,
  “API_KEY: “hx-Y5u4zx3kaF67AzkXK1hC”,
    “user_token”: “PkcLe7Co2G-50AoIVojGJ”
}
```

Similarly, a response from the generative output engine can include attribute fields such as, but not limited to: requester client ID; requester authentication tokens or other credentials; requester authorization tokens or other credentials; requester username; requester role; request timestamp; generative output generation time; request prompt; generative output formatted as a string; and so on. For example, a simple response to the preceding request may be JSON formatted and may be:

```
{
  “response” : “Hello world text goes here.”,
  “generation_time_ms” : 2
}
```

In some embodiments, a prompt provided as input to a generative output engine can be engineered from user input. For example, in some cases, a user input can be inserted into an engineered template prompt that itself is stored in a database. For example, an engineered prompt template can include one or more fields into which user input portions thereof can be inserted. In some cases, an engineered prompt template can include contextual information that narrows the scope of the prompt, increasing the specificity thereof.

For example, some engineered prompt templates can include example input/output format cues or requests that define for a generative output engine, as described herein, how an input format is structured and/or how output should be provided by the generative output engine.

### PROMPT PRE-CONFIGURATION, TEMPLATIZING, & ENGINEERING

As noted above, a prompt received from a user can be preconditioned and/or parsed to extract certain content therefrom. The extracted content can be used to inform selection of a particular engineered prompt template from a database of engineered prompt templates. Once the selected prompt template is selected, the extracted content can be inserted into the template to generate a populated engineered prompt template that, in turn, can be provided as input to a generative output engine as described herein.

In many cases, a particular engineered prompt template can be selected based on a desired task for which output of the generative output engine may be useful to assist. For example, if a user requires a summary of a particular document, the user input prompt may be a text string comprising the phrase “generate a summary of this page.” A software instance configured for prompt preconditioning—which may be referred to as a “preconditioning software instance” or “prompt preconditioning software instance”—may perform one or more substitutions of terms or words in this input phrase, such as replacing the demonstrative pronoun phrase “this page” with an unambiguous unique page ID. In this example, preconditioning software instance can provide an output of “generate a summary of the page with id 123456” which in turn can be provided as input to a generative output engine.

In an extension of this example, the preconditioning software instance can be further configured to insert one or more additional contextual terms or phrases into the user input. In some cases, the inserted content can be inserted at a grammatically appropriate location within the input phrase or, in other cases, may be appended or prepended as separate sentences. For example, in an embodiment, the preconditioning software instance can insert a phrase that adds contextual information describing the user making the initial input and request. In this example, output of the prompt preconditioning instance may be “generate a summary of the page with id 123456 with phrasing and detail appropriate for the role of user 76543.” In this example, if the user requesting the summary is an engineer, a different summary may be provided than if the user requesting the summary is a manager or executive.

In yet other examples, prompt preconditioning may be further contextualized before a given prompt is provided as input to a generative output engine. Additional information that can be added to a prompt (sometimes referred to as “contextual information” or “prompt context” or “supplemental prompt information”) can include but may not be limited to: user names; user roles; user tenure (e.g., new users may benefit from more detailed summaries or other generative content than long-term users); user projects; user groups; user teams; user tasks; user reports; tasks, assignments, or projects of a user's reports, and so on.

For example, in some embodiments, a user-input prompt may be “generate a table of all my tasks for the next two weeks, and insert the table into my home page in my personal space.” In this example, a preconditioning instance can replace “my” with a reference to the user's ID or another unambiguous identifier associated with the user. Similarly, the “home page in my personal space” can be replaced, contextually, with a page identifier that corresponds to that user's personal space and the page that serves as the homepage thereof. Additionally, the preconditioning instance can replace the referenced time window in the raw input prompt based on the current date and based on a calculated date two weeks in the future. With these two modifications, the modified input prompt may “generate a table of the tasks assigned to User 1234 dating from Jan. 1, 2023-Jan. 14, 2023 (inclusive), and insert the generated table into page 567.” In these embodiments, the preconditioning instance may be configured to access session information to determine the user ID.

In other cases, the preconditioning service may be configured to structure and submit a query to an active directory service or user graph service to determine user information and/or relationships to other users. For example, a prompt of “summarize the edits to this page made by my team since I last visited this page” could determine the user's ID, team members with close connections to that user based on a user graph, determine that the user last visited the page three weeks prior, and filter attribution of edits within the last three weeks to the current page ID based on those team members. With these modifications, the prompt provided to the generative output engine may be:

```
{
  “raw_prompt” : summarize the edits to this page made by
my team since I last visited this page”,
  “modified_prompt” : “Generate a summary of each
paragraph tagged with an editId attribute matching editId=1,
editId=51, editId=165, editId=99 within the following HTML-
formatted content: [HTML-formatted content of the page].”
}
```

Similarly, the preconditioning service may utilize a project graph, issue graph, or other data structure that is generated using edges or relationships between system objects that are determined based on express object dependencies, user event histories of interactions with related objects, or other system activity indicating relationships between system objects. The graphs may also associate system objects with particular users or user identifiers based on interaction logs or event histories.

Generally, a preconditioning service, as described herein, can be configured to access and append significant contextual information describing a user and/or users associated with the user submitting a particular request, the user's role in a particular organization, the user's technical expertise, the user's computing hardware (e.g., different response formats may be suitable and/or selectable based on user equipment), and so on.

In further implementations of this example, a snippet of prompt text can be selected from a snippet dictionary or table that further defines how the requested table should be formatted as output by the generative output engine. For example, a snippet selected from a database and appended to the modified prompt may be:

{
“snippet123_table_from_tasks” : “The table should be
formatted as a three-column table with multiple rows. The leftmost
column should be titled ‘Title’ and the corresponding content of each
row of this column should be the title attribute of a task. The middle
column should be titled ‘Created Date’ and the corresponding
content of each row of this column should be the creation date of the
task. The rightmost column should be titled ‘Status’ and the
corresponding content of each row of this column should be the
status attribute of the selected task.”
}

The foregoing examples of modifications and supplements to user input prompt are not exhaustive. Other modifications are possible. In one embodiment, the user input of “generate a table of all my tasks for the next two weeks” may be converted, supplemented, modified, and/or otherwise preconditioned to:

{
“modified_prompt” : “Find all tasks assigned to User 1234
dating from Jan 01, 2023 - Jan 14, 2023 (inclusive). Create a table
in which each found task corresponds to a respective row of that
table. The table should be formatted as a markdown table, in plain
text, with three columns. The leftmost column should be titled ‘Title’
and the corresponding content of each row of this column should be
the title attribute of a respective task. The middle column should be
titled ‘Created Date’ and the corresponding content of each row of
this column should be the creation date of the respective task. The
rightmost column should be titled ‘Status’ and the corresponding
content of each row of this column should be the status attribute of
the respective task.”
}

The operations of modifying a user input into a descriptive paragraph or set of paragraphs that further contextualize the input may be referred to as “prompt engineering.” In many embodiments, a preconditioning software instance may serve as a portion of a prompt engineering service configured to receive user input and to enrich, supplement, and/or otherwise hydrate a raw user input into a detailed prompt that may be provided as input to a generative output engine as described herein.

In other embodiments, a prompt engineering service may be configured to append bulk text to a prompt, such as document content in need of summarization or contextualization.

In other cases, a prompt engineering service can be configured to recursively and/or iteratively leverage output from a generative output engine in a chain of prompts and responses. For example, a prompt may call for a summary of all documents related to a particular project. In this case, a prompt engineering service may coordinate and/or orchestrate several requests to a generative output engine to summarize a first document, a second document, and a third document, and then generate an aggregate response of each of the three summarized documents. In yet other examples, staging of requests may be useful for other purposes.

### AUTHENTICATION & AUTHORIZATION

Still further embodiments reference systems and methods for maintaining compliance with permissions, authentication, and authorization within a software environment. For example, in some embodiments, a prompt engineering service can be configured to append to a prompt one or more contextualizing phrases that direct a generative output engine to draw insight from only a particular subset of content to which the requesting user has authorization to access.

In other cases, a prompt engineering service may be configured to proactively determine what data or database calls may be required by a particular user input. If data required to service the user's request is not authorized to be accessed by the user, that data and/or references to it may be restricted/redacted/removed from the prompt before the prompt is submitted as input to a generative output engine. The prompt engineering service may access a user profile of the respective user and identify content having access permissions that are consistent with a role, permissions profile, or other aspect of the user profile.

In other embodiments, a prompt engineering service may be configured to request that the generative output engine append citations (e.g., back links) to each page or source from which information in a generative response was based. In these examples, the prompt engineering service or another software instance can be configured to iterate through each link to determine (1) whether the link is valid, and (2) whether the requesting user has permission and authorization to view content at the link. If either test fails, the response from the generative output engine may be rejected and/or a new prompt may be generated specifically including an exclusion request such as “Exclude and ignore all content at XYZ.url.”

In yet other examples, a prompt engineering service may be configured to classify a user input into one of a number of classes of request. Different classes of request may be associated with different permissions handling techniques. For example, a class of request that requires a generative output engine to resource from multiple pages may have different authorization enforcement mechanisms or workflows than a class of request that requires a generative output engine to resource from only a single location.

These foregoing examples are not exhaustive. Many suitable techniques for managing permissions in a prompt engineering service and generative output engine system may be possible in view of the embodiments described herein.

More generally, as noted above, a generative output engine may be a portion of a larger network and communications architecture as described herein. This network can include input queues, prompt constructors, engine selection logical elements, request routing appliances, authentication handlers and so on.

### COLLABORATION PLATFORMS INTEGRATED WITH GENERATIVE OUTPUT SYSTEMS

In particular, embodiments described herein are focused to leveraging generative output engines to produce content in a software platform used for collaboration between multiple users, such as documentation tools, issue tracking platforms, project management systems, information technology service management systems, ticketing systems, repository systems, telecommunications systems, messaging systems, and the like, each of which may define different environments in which content can be generated by users of those systems. These types of platforms may be generally referred to herein as “collaboration platforms” or “content collaboration platforms.”

In one example, a documentation system may define an environment in which users of the documentation system can leverage a user interface of a frontend of the system to generate documentation in respect of a project, product, process, or goal. For example, a software development team may use a documentation system to document features and functionality of the software product. In other cases, the development team may use the documentation system to capture meeting notes, track project goals, and outline internal best practices.

Other software platforms store, collect, and present different information in different ways. For example, an issue tracking platform may be used to assign work within an organization and/or to track completion of work, a ticketing system may be used to track compliance with service level agreements, and so on. Any one of these software platforms or platform types can be communicably coupled to a generative output engine, as described herein, in order to automatically generate structured or unstructured content within environments defined by those systems.

In some implementations, a content collaboration system may include a documentation system, also referred to herein as a documentation platform, which can leverage a generative output engine to provide a generative answer interface to provide synthesized or generated responses leveraging content items hosted by the system. The documentation system may also leverage a generative output engine to provide, without limitation: summarize individual documents; summarize portions of documents; summarize multiple selected documents; generate document templates; generate document section templates; generate suggestions for cross-links to other documents or platforms; generate suggestions for adding detail or improving conciseness for particular document sections; and so on. As described with respect to examples provided herein, a documentation system can store user-generated content in electronic documents or electronic pages, also referred to herein simply as documents or pages. The documents or pages may include a variety of user-generated content including text, images, video and links to content provided by other platforms. The documentation system may also save user interaction events including user edit action, content viewing actions, commenting, content sharing, and other user interactions. The document content in addition to select user interaction events may be indexed and searchable by the system. In some examples, the documentation system may organize documents or pages into a document space, which defines a hierarchical relationship between the pages and documents and also defines a permissions profile or scheme for the documents or pages of the space.

In some implementations, a content collaboration system may include an issue tracking platform or task management system (also referred to herein as issue tracking platforms or issue management platforms). The issue tracking platform may also leverage a generative output engine to provide a generative answer interface to provide synthesized or generated responses leveraging content items (e.g., issues or tasks) hosted by the system. The issue tracking platform may also leverage a generative output engine to provide, without limitation: summarize issues; summarize portions of issues or fields of issues; summarize multiple selected issues, tasks, or events; generate issue templates; and so on. As described with respect to examples provided herein, an issue tracking platform can manage various issues or tasks that are processed in accordance with an automated workflow. The workflow may define a series of states that the issue or task must traverse before being completed. The system may also track user interaction events, issue state transitions, and other events that occur over the lifecycle of the issue, which may be indexed and searchable by the system.

More broadly, it may be appreciated that a single organization may be a tenant of multiple software platforms, of different software platform types. Generally and broadly, regardless of configuration or purpose, a software platform that can serve as source information for operation of a generative output engine as described herein may include a frontend and a backend configured to communicably couple over a computing network (which may include the open Internet) to exchange computer-readable structured data.

The frontend may be a first instance of software executing on a client device, such as a desktop computer, laptop computer, tablet computer, or handheld computer (e.g., mobile phone). The backend may be a second instance of software executing over a processor allocation and memory allocation of a virtual or physical computer architecture. In many cases, although not required, the backend may support multiple tenancies. In such examples, a software platform may be referred to as a multi-tenant software platform.

For simplicity of description, the multi-tenant embodiments presented herein reference software platforms from the perspective of a single common tenant. For example, an organization may secure a tenancy of multiple discrete software platforms, providing access for one or more employees to each of the software platforms. Although other organizations may have also secured tenancies of the same software platforms which may instantiate one or more backends that serve multiple tenants, it is appreciated that data of each organization is siloed, encrypted, and inaccessible to, other tenants of the same platform.

In many embodiments, the frontend and backend of a software platform—multi-tenant or otherwise—as described herein are not collocated, and communicate over a large area and/or wide area network by leveraging one or more networking protocols, but this is not required of all implementations.

A frontend of a software platform, also referred to as a frontend or client application, may be configured to render a graphical user interface at a client device that instantiates frontend software. As a result of this architecture, the graphical user interface of the frontend can receive inputs from a user of the client device, which, in turn, can be formatted by the frontend into computer-readable structured data suitable for transmission to the backend for storage, transformation, and later retrieval. One example architecture includes a graphical user interface rendered in a browser executing on the client device. In other cases, a frontend may be a native application executing on a client device. Regardless of architecture, it may be appreciated that generally and broadly a frontend of a software platform as described herein is configured to render a graphical user interface to receive inputs from a user of the software platform and to provide outputs to the user of the software platform.

Input to a frontend of a software platform by a user of a client device within an organization may be referred to herein as “organization-owned” content. With respect to a particular software platform, such input may be referred to as “tenant-owned” or “platform-specific” content. In this manner, a single organization's owned content can include multiple buckets of platform-specific content.

Herein, the phrases “tenant-owned content” and “platform-specific content” may be used to refer to any and all content, data, metadata, or other information regardless of form or format that is authored, developed, created, or otherwise added by, edited by, or otherwise provided for the benefit of, a user or tenant of a multi-tenant software platform. In many embodiments, as noted above, tenant-owned content may be stored, transmitted, and/or formatted for display by a frontend of a software platform as structured data. In particular structured data that includes tenant-owned content may be referred to herein as a “data object” or a “tenant-specific data object.”

In a more simple, non-limiting phrasing, any software platform described herein can be configured to store one or more data objects in any form or format unique to that platform. Any data object of any platform may include one or more attributes and/or properties or individual data items that, in turn, include tenant-owned content input by a user.

Example tenant-owned content can include personal data, private data, health information, personally-identifying information, business information, trade secret content, copyrighted content or information, restricted access information, research and development information, classified information, mutually-owned information (e.g., with a third party or government entity), or any other information, multi-media, or data. In many examples, although not required, tenant-owned content or, more generally, organization-owned content may include information that is classified in some manner, according to some procedure, protocol, or jurisdiction-specific regulation.

In particular, the embodiments and architectures described herein can be leveraged by a provider of multi-tenant software and, in particular, by a provider of suites of multi-tenant software platforms, each platform being configured for a different particular purpose. Herein, providers of systems or suites of multi-tenant software platforms are referred to as “multiplatform service providers.”

In general, customers/clients of a multiplatform service provider are typically tenants of multiple platforms provided by a given multiplatform service provider. For example, a single organization (a client of a multiplatform service provider) may be a tenant of a messaging platform and, separately, a tenant of a project management platform.

The organization can create and/or purchase user accounts for its employees so that each employee has access to both messaging and project management functionality. In some cases, the organization may limit seats in each tenancy of each platform so that only certain users have access to messaging functionality and only certain users have access to project management functionality; the organization can exercise discretion as to which users have access to either or both tenancies.

In another example, a multiplatform service provider can host a suite of collaboration tools. For example, a multiplatform service provider may host, for its clients, a multi-tenant issue tracking platform, a multi-tenant code repository service, and a multi-tenant documentation service. In this example, an organization that is a customer/client of the service provider may be a tenant of each of the issue tracking system or platform, a code repository system or platform (also referred to as a source-code management system or platform), and/or a documentation system or platform.

As with preceding examples, the organization can create and/or purchase user accounts for its employees, so that certain selected employees have access to one or more of issue tracking functionality, documentation functionality, and code repository functionality.

In this example and others, it may be possible to leverage multiple collaboration platforms to advance individual projects or goals. For example, for a single software development project, a software development team may use (1) a code repository to store project code, executables, and/or static assets, (2) a documentation platform to maintain documentation related to the software development project, (3) an issue tracking platform to track assignment and progression of work, and (4) a messaging service or platform to exchange information directly between team members. However, as organizations grow, as project teams become larger, and/or as software platforms mature and add features or adjust user interaction paradigms over time, using multiple software platforms can become inefficient for both individuals and organizations. Further, as described herein, it can be difficult to locate content or answer queries in a multiplatform system having diverse content and data structures used to provide the various content items. As described herein, a generative answer interface may be adapted to access multi-platform content and provide generative responses that bridge various content item types and platform structures.

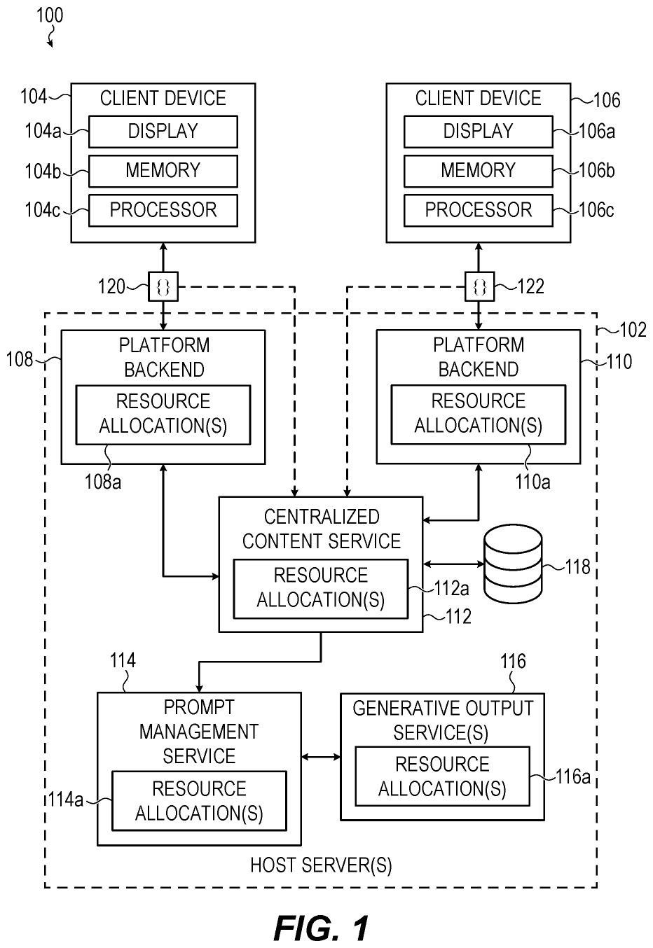

These foregoing and other embodiments are discussed below with reference to FIGS. 1-12. The detailed description given herein with respect to these figures is for explanation only and should not be construed as limiting.

### USER INPUT RESULTING IN GENERATIVE OUTPUT

FIG. 1 depicts a simplified diagram of a system, such as described herein that can include and/or may receive input from a generative output engine as described herein. The system 100 is depicted as implemented in a client-server architecture, but it may be appreciated that this is merely one example and that other communications architectures are possible.

In particular the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location. The set of host servers 102 can be communicably coupled to one or more client devices; two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other examples include ITSM systems, chat platforms, messaging platforms, and the like. These backends can be communicably coupled to a generative output engine that can be leveraged to provide unique intelligent functionality to each respective backend. For example, the generative output engine can be configured to receive user prompts, such as described above, to modify, create, or otherwise perform operations against content stored by each respective software platform.

By centralizing access to the generative output engine in this manner, the generative output platform can also serve as an integration between multiple platforms. For example, one platform may be a documentation platform and the other platform may be an issue tracking platform. In these examples, a user of the documentation platform may input a prompt requesting a summary of the status of a particular project documented in a particular page of the documentation platform. A comprehensive continuation/response to this summary request may pull data or information from the issue tracking platform as well.

A user of the client devices may trigger production of generative output in a number of suitable ways. One example is shown in FIG. 1. In particular, in this embodiment, each of the software platforms can share a common feature, such as a common centralized editor rendered in a frame of the frontend user interfaces of both platforms.

Turning to FIG. 1, a portion of the set of host servers 102 can be allocated as physical infrastructure supporting a first platform backend 108 and a different portion of the set of host servers 102 can be allocated as physical infrastructure supporting a second platform backend 110.

The two different platforms may be instantiated over physical resources provided by the set of host servers 102. Once instantiated, the first platform backend 108 and the second platform backend 110 can each communicably couple to a centralized content service 112. The centralized content service may be a search interface, generative content service or, in some cases, a centralized editing service which may also referred to more simply as an “editor” or an “editor service.”

In implementations in which the centralized content service 112 is a search interface or generative content service, the service 112 may be instantiated or implemented in response to a user input provided to a frontend application in communication with one of the platform backends 108, 110. The service 112 may be configured to leverage authenticated user sessions between multiple platforms in order to access content and provide aggregated or composite results to the user. The service 112 may be instantiated as a plugin to the respective frontend application, may be integrated with the frontend application or, in some implementations, may be instantiated as a separate and distinct service or application instance.

In implementations in which this centralized content service 112 is an editing service, the centralized content service 112 may be referred to as a centralized content editing frame service 112. The centralized content editing frame service 112 can be configured to cause rendering of a frame within respective frontends of each of the first platform backend 108 and the second platform backend 110. In this manner, and as a result of this construction, each of the first platform and the second platform present a consistent user content editing experience.

More specifically, the centralized content editing frame service 112 may be a rich text editor with added functionality (e.g., slash command interpretation, in-line images and media, and so on). As a result of this centralized architecture, multiple platforms in a multiplatform environment can leverage the features of the same rich text editor. This provides a consistent experience to users while dramatically simplifying processes of adding features to the editor.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized content service 112 that can be called by each respective frontend whenever it is required to present the user of that respective frontend with an interface to edit text.

For example, the documentation platform's frontend may call upon the centralized content service 112 to render, or assist with rendering, a user input interface element to receive user text input in a generative interface of a documentation platform. Similarly, the issue tracking platform's frontend may call upon the centralized content service 112 to render, or assist with rendering, a user input interface element to receive user text input or other input in a generative interface. In these examples, the centralized content service 112 can parse text input provided by users of the documentation platform frontend and/or the issue tracking platform backend, monitoring for command and control keywords, phrases, trigger characters, and so on. In many cases, for example, the centralized content service 112 can implement a slash command service that can be used by a user of either platform frontend to issue commands to the backend of the other system. As described herein, the centralized content service 112 may cause display of a generative answer interface having input regions and controls that can be used to receive user input and provide commands to the system.

In one example, the user of the documentation platform frontend can input a slash command to the content editing frame, rendered in the documentation platform frontend supported by the centralized content service 112, in order to type a prompt including an instruction to create a new issue or a set of new issues in the issue tracking platform. Similarly, the user of the issue tracking platform can leverage slash command syntax, enabled by the centralized content service 112, to create a prompt that includes an instruction to edit, create, or delete a document stored by the documentation platform.

As described herein, a “content editing frame” references a user interface element that can be leveraged by a user to draft and/or modify rich content including, but not limited to: formatted text; image editing; data tabling and charting; file viewing; and so on. These examples are not exhaustive; the content editing elements can include and/or may be implemented to include many features, which may vary from embodiment to embodiment. For simplicity of description the embodiments that follow reference a centralized content service 112 configured for rich text editing, but it may be appreciated that this is merely one example.

As a result of architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In addition, as a result of the architectures described herein, services supporting the centralized content service 112 can be extended to include additional features and functionality—such as a user input field, selectable control, a slash command processor, or other user interface element—which, in turn, can automatically be leveraged by any further platform that incorporates a generative interface, and/or otherwise integrates with the centralized content service 112 itself. In this example, commands or input facilitated by the generative service can be used to receive prompt instructions from users of either frontend. These prompts can be provided as input to a prompt engineering/prompt preconditioning service (such as the prompt management service 114) that, in turn, provides a modified user prompt as input to a generative engine service 116.

The generative output engine service may be hosted over the host servers 102 or, in other cases, may be a software instance instantiated over separate hardware. In some cases, the generative engine service may be a third-party service that serves an API interface to which one or more of the host services and/or preconditioning service can communicably couple.

The generative output engine can be configured as described above to provide any suitable output, in any suitable form or format. Examples include content to be added to user-generated content, API request bodies, replacing user-generated content, and so on.

In addition, a centralized content service 112 can be configured to provide suggested prompts to a user as the user types. For example, as a user begins typing a slash command in a frontend of some platform that has integrated with a centralized content service 112 as described herein, the centralized content service 112 can monitor the user's typing to provide one or more suggestions of prompts, commands, or controls (herein, simply “preconfigured prompts”) that may be useful to the particular user providing the text input. The suggested preconfigured prompts may be retrieved from a database 118. In some cases, each of the preconfigured prompts can include fields that can be replaced with user-specific content, whether generated in respect of the user's input or generated in respect of the user's identity and session.

In some embodiments, the centralized content service 112 can be configured to suggest one or more prompts that can be provided as input to a generative output engine as described herein to perform a useful task, such as summarizing content rendered within the centralized content service 112, reformatting content rendered within the centralized content service 112, inserting cross-links within the centralized content service 112, and so on.

The ordering of the suggestion list and/or the content of the suggestion list may vary from user to user, user role to user role, and embodiment to embodiment. For example, when interacting with a documentation system, a user having a role of “developer” may be presented with prompts, content, or functionality associated with tasks related to an issue tracking platform and/or a code repository system. Alternatively, when interacting with the same documentation system, a user having a role of “human resources professional” may be presented with prompts, content, or functionality associated with manipulating or summarizing information presented in a directory system or a benefits system, instead of the issue tracking platform or the code repository system.

More generally, in some embodiments described herein, a centralized content service 112 can be configured to suggest to a user one or more prompts that can cause a generative output engine to provide useful output and/or perform a useful task for the user. These suggestions/prompts can be based on the user's role, a user interaction history by the same user, user interaction history of the user's colleagues, or any other suitable filtering/selection criteria.

In addition to the foregoing, a centralized content service 112 as described herein can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More generally and broadly, the embodiments described herein refence systems and methods for sharing user interface elements rendered by a centralized content service 112 and features thereof (such as input fields or a slash command processor), between different software platforms in an authenticated and secure manner. For simplicity of description, the embodiments that follow reference a configuration in which a centralized content editing frame service is configured to implement user input fields, selectable controls, a slash command processor, or other user interface elements.

More specifically, the first platform backend 108 can be configured to communicably couple to a first platform frontend instantiated by cooperation of a memory and a processor of the client device 104. Once instantiated, the first platform frontend can be configured to leverage a display of the client device 104 to render a graphical user interface so as to present information to a user of the client device 104 and so as to collect information from a user of the client device 104. Collectively, the processor, memory, and display of the client device 104 are identified in FIG. 1 as the client devices resources 104a-104c, respectively.

As with many embodiments described herein, the first platform frontend can be configured to communicate with the first platform backend 108 and/or the centralized content service 112. Information can be transacted by and between the frontend, the first platform backend 108 and the centralized content service 112 in any suitable manner or form or format. In many embodiments, as noted above, the client device 104 and in particular the first platform frontend can be configured to send an authentication token 120 along with each request transmitted to any of the first platform backend 108 or the centralized content service 112 or the preconditioning service or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a graphical user interface so as to present information to a user of the client device 106 and so as to collect information from a user of the client device 106. Collectively, the processor, memory, and display of the client device 106 are identified in FIG. 1 as the client devices resources 106a-106c, respectively.

As with many embodiments described herein, the second platform frontend can be configured to communicate with the second platform backend 110 and/or the centralized content service 112. Information can be transacted by and between the frontend, the second platform backend 110 and the centralized content service 112 in any suitable manner or form or format. In many embodiments, as noted above, the client device 106 and in particular the second platform frontend can be configured to send an authentication token 122 along with each request transmitted to any of the second platform backend 110 or the centralized content editing frame service 112.

As a result of these constructions, the centralized content service 112 can provide uniform feature sets to users of either the client device 104 or the client device 106. For example, the centralized content service 112 can implement a user input field, selectable controls, a slash command processor, or other user interface element to receive prompt input and/or preconfigured prompt selection provided by a user of the client device 104 to the first platform and/or to receive input provided by a different user of the client device 106 to the second platform.

As noted above, the centralized content service 112 ensures that common features, such as user input interpretation, slash command handling, or other input techniques are available to frontends of different platforms. One such class of features provided by the centralized content service 112 invokes output of a generative output engine of a service such as the generative engine service 116.

For example, as noted above, the generative engine service 116 can be used to generate content, supplement content, and/or generate API requests or API request bodies that cause one or both of the first platform backend 108 or the second platform backend 110 to perform a task. In some cases, an API request generated at least in part by the generative engine service 116 can be directed to another system not depicted in FIG. 1. For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

As with other embodiments described herein, the prompt management service 114 can be configured to receive user input (provided via a graphical user interface of the client device 104 or the client device 106) from the centralized content service 112. The user input may include a prompt to be continued by the generative engine service 116.

The prompt management service 114 can be configured to modify the user input, to supplement the user input, select a prompt from a database (e.g., the database 118) based on the user input, insert the user input into a template prompt, replace words within the user input, preform searches of databases (such as user graphs, team graphs, and so on) of either the first platform backend 108 or the second platform backend 110, change grammar or spelling of the user input, change a language of the user input, and so on. The prompt management service 114 may also be referred to herein as herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative engine service 116 as an input. More particularly, the prompt management service 114 is configured to structure an API request to the generative engine service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative engine service 116 should process the request; an output format or encryption identifier; and so on. One example of such an API request is a POST request to a Restful API endpoint served by the generative engine service 116. In other cases, the prompt management service 114 may transmit data and/or communicate data to the generative engine service 116 in another manner (e.g., referencing a text file at a shared file location, the text file including a prompt, referencing a prompt identifier, referencing a callback that can serve a prompt to the generative engine service 116, initiating a stream comprising a prompt, referencing an index in a queue including multiple prompts, and so on; many configurations are possible).

In response to receiving a modified prompt as input, the generative engine service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114. In other cases, output of the generative engine service 116 can be provided to the centralized content service 112 to return to a suitable backend application, to in turn return to or perform a task for the benefit of a client device such as the client device 104 or the client device 106. More particularly, it may be appreciate that although FIG. 1 is illustrated with only the prompt management service 114 communicably coupled to the generative engine service 116, this is merely one example and that in other cases the generative engine service 116 can be communicably coupled to any of the client device 106, the client device 104, the first platform backend 108, the second platform backend 110, the centralized content service 112, or the prompt management service 114.

In some cases, output of the generative engine service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative engine service 116 to the frontend (e.g., rendered on the client device 104, as one example) so that a user of the client device 104 can approve the content before it is prepended to the document. In another example, output of the generative engine service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative engine service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, the embodiments described herein and with particular reference to FIG. 1 relate to systems for collecting user input, modifying that user input into a particularly engineered prompt, and submitting that prompt as input to a trained large language model. Output of the LLM can be used in a number of suitable ways.

In some embodiments, user input can be provided by text input that can be provided by a user typing a word or phrase into an editable dialog box such as a rich text editing frame rendered within a user interface of a frontend application on a display of a client device. For example, the user can type a particular character or phrase in order to instruct the frontend to enter a command receptive mode. In some cases, the frontend may render an overlay user interface that provides a visual indication that the frontend is ready to receive a command from the user. As the user continues to type, one or more suggestions may be shown in a modal UI window.

These suggestions can include and/or may be associated with one or more “preconfigured prompts” that are engineered to cause an LLM to provide particular output. More specifically, a preconfigured prompt may be a static string of characters, symbols and words, that causes—deterministically or pseudo-deterministically—the LLM to provide consistent output. For example, a preconfigured prompt may be “generate a summary of changes made to all documents in the last two weeks.” Preconfigured prompts can be associated with an identifier or a title shown to the user, such as “Summarize Recent System Changes.” In this example, a button with the title “Summarize Recent System Changes” can be rendered for a user in a UI as described herein. Upon interaction with the button by the user, the prompt string “generate a summary of changes made to all documents in the last two weeks” can be retrieved from a database or other memory, and provided as input to the generative engine service 116.

Suggestions rendered in a UI can also include and/or may be associated with one or more configurable or “templatized prompts” that are engineered with one or more fields that can be populated with data or information before being provided as input to an LLM. An example of a templatized prompt may be “summarize all tasks assigned to ${user} with a due date in the next 2 days.” In this example, the token/field/variable ${user} can be replaced with a user identifier corresponding to the user currently operating a client device.

This insertion of an unambiguous user identifier can be performed by the client device, the platform backend, the centralized content editing frame service, the prompt management service, or any other suitable software instance. As with preconfigured prompts, templatized prompts can be associated with an identifier or a title shown to the user, such as “Show My Tasks Due Soon.” In this example, a button with the title “Show My Tasks Due Soon” can be rendered for a user in a UI as described herein. Upon interaction with the button by the user, the prompt string “summarize all tasks assigned to user123 with a due date in the next 2 days” can be retrieved from a database or other memory, and provided as input to the generative engine service 116.

Suggestions rendered in UI can also include and/or may be associated with one or more “engineered template prompts” that are configured to add context to a given user input. The context may be an instruction describing how particular output of the LLM/engine should be formatted, how a particular data item can be retrieved by the engine, or the like. As one example, an engineered template prompt may be “${user prompt}. Provide output of any table in the form of a tab delimited table formatted according to the markdown specification.” In this example, the variable ${user prompt} may be replaced with the user prompt such that the entire prompt received by the generative engine service 116 can include the user prompt and the example sentence describing how a table should be formatted.

In yet other embodiments, a suggestion may be generated by the generative engine service 116. For example, in some embodiments, a system as described herein can be configured to assist a user in overcoming a cold start/blank page problem when interacting with a new document, new issue, or new board for the first time. For example, an example backend system may be Kanban board system for organizing work associated with particular milestones of a particular project. In these examples, a user needing to create a new board from scratch (e.g., for a new project) may be unsure how to begin, causing delay, confusion, and frustration.

In these examples, a system as described herein can be configured to automatically suggest one or more prompts configured to obtain output from an LLM that programmatically creates a template board with a set of template cards. Specifically, the prompt may be a preconfigured prompt as described above such as “generate a JSON document representation of a Kanban board with a set of cards each representing a different suggested task in a project for creating a new iced cream flavor.” In response to this prompt, the generative engine service 116 may generate a set of JSON objects that, when received by the Kanban platform, are rendered as a set of cards in a Kanban board, each card including a different title and description corresponding to different tasks that may be associated with steps for creating a new iced cream flavor. In this manner, the user can quickly be presented with an example set of initial tasks for a new project.

In yet other examples, suggestions can be configured to select or modify prompts that cause the generative engine service 116 to interact with multiple systems. For example, a suggestion in a documentation system may be to create a new document content section that summarizes a history of agent interactions in an ITSM system. In some cases, the generative engine service 116 can be called more than once and/or it may be configured to generate its own follow-up prompts or prompt templates which can be populated with appropriate information and re-submitted to the generative engine service 116 to obtain further generative output. More simply, in some embodiments, generative output may be recursive, iterative, or otherwise multi-step in some embodiments.

These foregoing embodiments depicted in FIG. 1 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a.

Similarly, the second platform backend 110 may be instantiated over the resource allocations 110a (including processors, memory, storage, network communications systems, and so on). Likewise, the centralized content service 112 is supported by a processor and memory and network connection (and/or database connections) collectively represented for simplicity as the resource allocations 112a.

The prompt management service 114 can be supported by its own resources including processors, memory, network connections, displays (optionally), and the like represented in the figure as the resource allocations 114a.

In many cases, the generative engine service 116 may be an external system, instantiated over external and/or third-party hardware which may include processors, network connections, memory, databases, and the like. In some embodiments, the generative engine service 116 may be instantiated over physical hardware associated with the host servers 102. Regardless of the physical location at which (and/or the physical hardware over which) the generative engine service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generally, generative output systems, as described herein, should not be usable to obtain information from an organization's datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to Kanban board 456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to Kanban board 456, and whether the requesting user has read access to referenced issue tracking platform. In some embodiments, the request may be modified to accommodate a user's limited permissions. In other cases, the request may be rejected outright before providing any input to the generative engine service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect key words or phrases that indicate potential content violations. A trained model may also be used that has been trained using content known to be in violation of the content guidelines or policies.

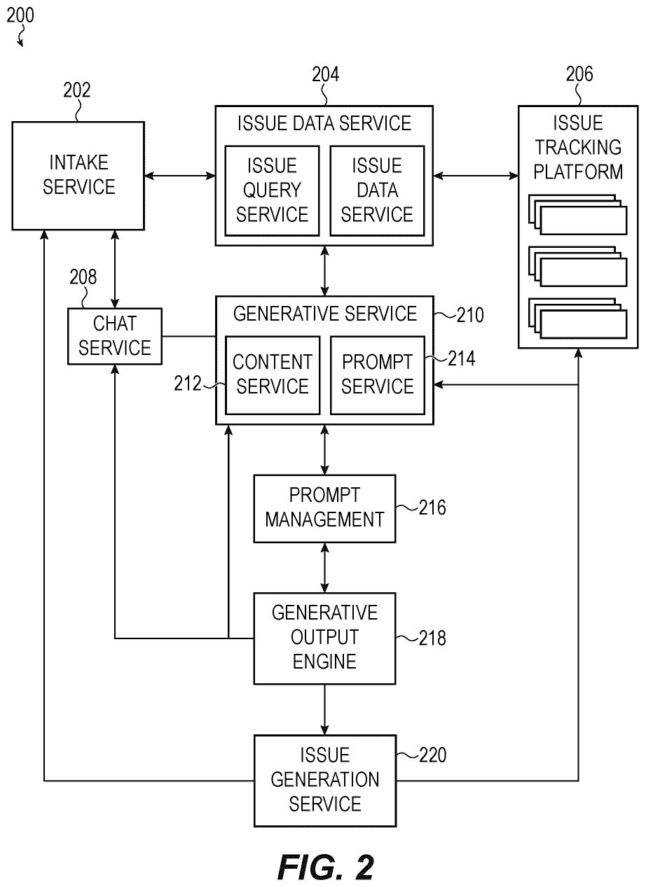

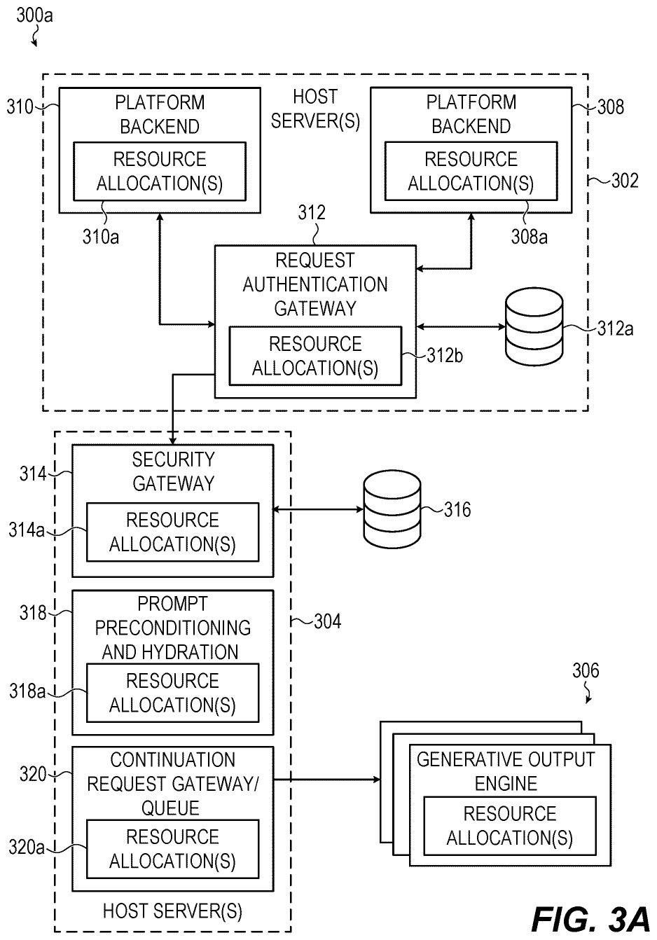

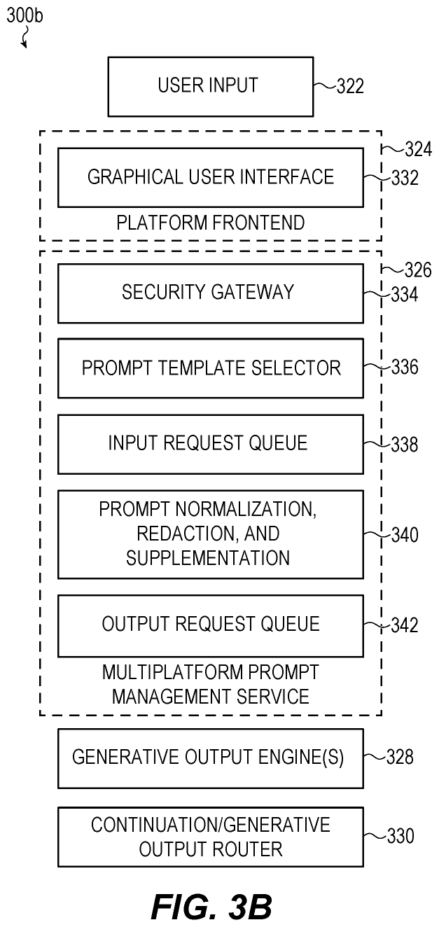

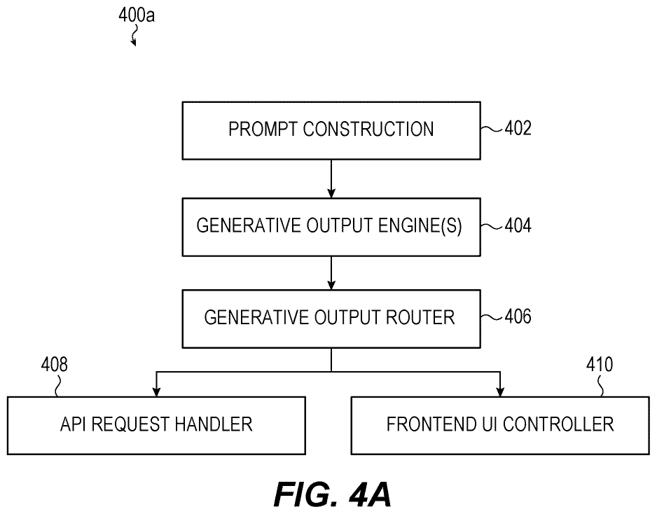

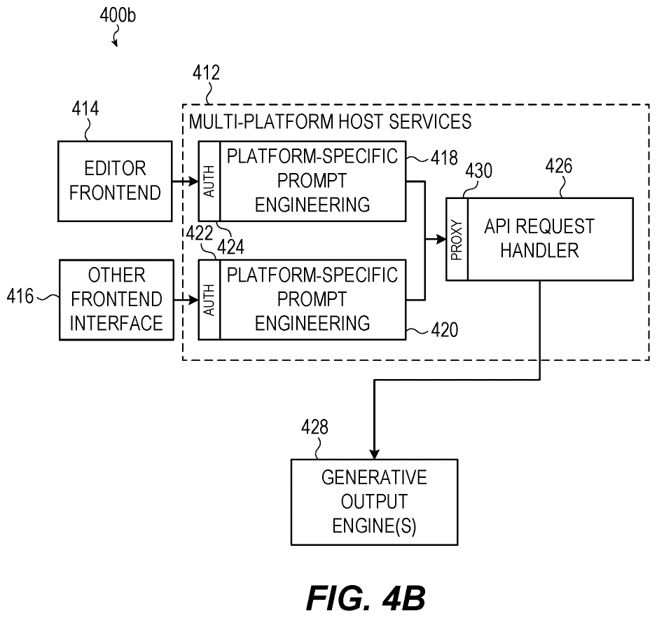

FIG. 2 depicts an example system 200 for using a generative output engine to generate a project and one or more issues as part of an account activation at an issue tracking platform. The system 200 can be used to generate and submit prompts to a generative output engine and receive a generative response as described herein. The system 200 can also leverage elements and system components described above in FIG. 1 and below with respect to FIGS. 3A-4B.

The system 200 may also be directed to provide more specific assistance directed to issue creation by coordinating generative content and actions with a corresponding issue tracking platform. The system 200 may be similarly adapted for a range of other platform specific or use-case specific scenarios by allowing the system to leverage content from a wide range of designated content, which may be curated or adapted to provide specific services and resources. In the following example, various services or modules are depicted as distinct elements for purposes of demonstration. However, in any particular implementation, elements may be combined or integrated together to provide the same or similar services or operations, as described herein.

In the example of FIG. 2, the system 200 includes an intake service 202, which serves as the gateway or portal for a variety of sources of user input and/or system generated input. In accordance with many of the examples provided herein, the intake service 202 may be linked to or operated as a generative interface, which is configured to receive platform generated inputs (e.g., a prompt including issue tracking platform data) and other user input. Additionally or alternatively, the intake service 202 may receive input from a variety of other sources including, for example an issue data service 204 and a chat service 208. The chat service 208 may include a chat-based interface that is incorporated into another graphical user interface or platform frontend or, alternatively, may be a dedicated chat-based platform. Independent of the platform or specific interface, a range of external services or frontends may leverage the system 200 by either accessing the intake service 202 via an application programming interface or through a direct call to the intake service 202.

In some cases, the intake service 202 can be configured to cause display on an intake interface on a client device, as described herein. The intake interface 202 can display selectable objects, text-based input objects or other graphical objects on a client device and receive inputs to the interface via the client device. The intake interface 202 can communicate with one or more services to generate content displayed on the interface including the chat service 208, a generative service 210 and/or the issue tracking platform 206.

In some cases, the intake service 202 can be configured to extract issue data and/or issue clusters and generate inputs to a generative service 210. For example, the intake service 202 can include a module that performs clustering analysis on issues and/or identifies when an activity criteria is satisfied. The intake service 202 can extract relevant issue data, such as an issue title, issue summary, workflows, compliance with service level agreements and so on, and configure this data for submission to a generative output engine 218 using the generative service 210.

As shown in FIG. 2, the intake service 202 may include or be coupled to a generative service 210, which may also be referred to herein as an answer service. The generative service 210 is configured to provide generative responses or other generative content that leverages designated content provided by the issue tracking platform 206. The generative service 210 may also include services or modules that are able to provide various preprocessing and postprocessing operations described with respect to other systems herein.

In this example, the intake service 202 includes or is operably coupled to multiple analysis modules, which are adapted to produce or generate different feature sets or analyses of the natural language user input provided by the intake service 202. In one example, an analysis module includes a natural language processor that is adapted to extract key words or phrases from the natural language user input. The analysis modules may perform lemmatization and/or tokenization operations on the natural language user input to obtain the key words or phrases that define the feature set. The analysis module may remove stop words including articles, common verbs, and other words that are predicted to have a minimal impact on the substance of the query. The analysis module may also extract identified tokens or segments of the input that may be subjected to a lemmatization or other service to determine a set of keywords or search terms. In some cases, word embedding operations are also performed, which may result in an expanded feature set that can be used by the system 200. These techniques are provided by way of example and other natural language processing techniques can be used to obtain a set of keywords or search terms.

The issue data service 204 can be configured to receive user input data from the intake service 202 and generate a search query for the issue tracking platform 206. The issue data service 204 can analyze the user input and extract data from the user input that can be used to define search parameters for the search query. The issue data service 204 can include one or more modules that are configured to perform these tasks. For example, the issue data service 204 can include an issue query service module which analyzes user input and generates a structured search query using the user input. The issue query service module can be configured to format the search query for the issue tracking platform 206.

Data received from the issue tracking platform 206, in response to the search query, can be analyzed by the issue data service module and passed to the generative service 210 and used to generate a prompt. In some cases, the issue data service module can be configured to extract specific types of information or content from the search results received from the issue tracking platform 206. For example, when data received from the issue tracking platform is formatted according to a particular data structure (e.g., JSON data structure), the issue data service module can be configured to identify and extract particular data from the structured data file and pass that data to the generative service 210.

The generative service 210 may implement a content service 212, which is able take the natural language user input and/or the results of the intake service 202 and/or issue data service 204 in order to formulate content requests that are served to the issue tracking platform 206. The content service 212 may include or have access to a registry of registered platforms or content providers that are accessible to the generative service 210. The registry may include an address or network location of each of the respective platforms, a list of designated content associated with each platform, and a search classifier that indicates the type or class of input that the platform is configured to use for content retrieval. For example, the search classifier may indicate which type or class of feature set should be used with each respective platform or content provider. Some platforms are adapted to identify content using a set of key words or phrases and other platforms may be adapted to identify content using statements of intent or other semantic features. The registry may also include additional information including authentication information for platforms that provide secure content, keywords or intent classifying information that can be used for platform selection, and other data that facilitates efficient and accurate content retrieval.

The content service 212 formulates respective content requests that will be provided to the issue tracking platform 206. Each content request may include a feature set or other analysis of the user input, as generated by a respective analysis module at the intake service 202. For secure content, the request may also include authentication data including, for example authentication credentials, an authentication token, certificate, or other data element that can be used for authenticating the user. The authentication data may be obtained from a trusted authentication service or passed along by the hosting platform or service. The content service 212 may be provided access on par with or no greater than access granted to the user initiating the request or providing the user input. The content request may also be formulated in accordance with platform specific schema and, in some implementations, is provided as an application programming interface (API) call. The content requests may be paired or grouped in accordance with common or shared search classifiers such that a shared or common feature set may be used for each of the requests in the group. Grouped requests may be executed concurrently, may be executed in series, or in an order determined by content service 212.

In response to a respective content request, the issue tracking platform 206 may conduct a search of respective designated content in order to provide results that are passed back to the content service 212. The designated content may be stored in a shared directory, workspace, or other content partition or group. The designated content may also be distributed across a platform or content provider. In the illustrated example, the issue tracking platform 206 may include multiple groups of designated content, which may be searched in response to a single request or the request may include a particular set of designated content implicitly excluding other designated content.

The issue tracking platform 206 may conduct a search of issues and issue data stored at the platform in order to provide results that are passed back to the content service 212. The passed issues and issue data can be searched (or otherwise identified) by the corresponding platform based on a clustering analysis, issue data satisfying a particular criteria and/or in response to other queries that result as a part of generating a prompt from a generative output engine, as described herein.

As discussed previously, the designated content may be selected based on a predicted veracity or vetting conducted by platform operators. In general, the designated content includes text content also referred to herein as textual content. The designated content may also include structured data that is non-textual content including multimedia content, issue or ticket objects, or platform-specific content. As used herein, the term “structured content” may be used to refer to non-textual content that has been formatted or is stored in accordance with a predefined schema or format. The system 200 may be configured to access and analyze some structured content but other structured content may be considered proprietary or unavailable for system access. For such structured content, the system 200 may pass along a link or reference to the structured content and omit more detailed analysis of the content.

In response to a series or set of content requests, the issue tracking platform 206 may produce a set of results, which may include content items, extracted text, aggregated search results or other forms of content corresponding to the feature sets provided in each respective request. The results returned may be aggregated by the generative service 210 and included in a prompt as data extracted from a set of issues. The aggregated results may be processed to extract top-scoring or top-ranking results, which may be used to formulate a prompt using the prompt service 214. In one example, the aggregated results are processed by the generative service 210 to produce an aggregated set of text snippet portions. The generative service 210 may, for example identify text blocks in each content item or in the aggregated search results and may extract respective text snippet portions that include at least an extraction threshold number of sentences or phrases. For example, the first two sentences of each text block (e.g., paragraph, section, or other grouping of text) may be extracted as a text snippet portion. In other examples, the first three, four, five or six sentences or phrases are extracted from each respective text block. In some cases, the extraction threshold number of sentences is scaled for each text block such that an approximate percentage or ratio of text is extracted from each text block. In other cases, a natural language processing technique is used to identify topic and supporting sentences, which are extracted as text snippet portions. Other natural language processing techniques may eliminate text that is predicted to be contextual, redundant, or non-essential to the text block and remaining text is designated as the respective text snippet portion.

The text snippet portions that have been aggregated by the generative service 210 may be evaluated with respect to the natural language user input or a representative thereof. For example, each text snippet portion may be subjected to an embedding operation and/or generate a multi-dimensional vector representation of the text. An example embedding operation may add synonyms and predicted corresponding words to words or phrases of the respective text snippet. Additionally, the text snippets may be represented as a vector or other multi-dimensional data element allowing for comparison to a similarly vectorized or processed representation of the natural language user input. For example, a representative vector may be constructed using a word vectorization service that maps words or phrases into a vector of numbers or other characters. A comparison of each vector or other representation may be performed with respect to the user input to determine a degree of correlation or similarity. In one example implementation, a cosine similarity or other similar comparison is performed between respective vectors and a score or value is determined for each pairing. The evaluated snippets may be ranked or sorted by degree of correlation and a subset of snippets may be selected for use in constructing a prompt. In some cases, a threshold score or other degree of correlation is used to select the subset of snippets. In other cases, a threshold number of top scoring results are selected. In other examples, the top-scoring results that provide a threshold number of characters or aggregated snippet size are selected.

The selected or subset of text snippet portions may then be used by the prompt service 214 to construct a prompt that is designed to provoke a relevant and useful generative response from the generative output engine 218. The prompt service 214 may combine the subset of text snippet portions, context data, at least a portion of the user input, and predetermined prompt text (also referred to as predetermined query prompt text, template prompt text, or simply prompt text) in order to generate or complete the prompt that will be transmitted to the generative output engine 218. The predetermined prompt text may include one of a number of predetermined phrases that provide instructions to the generative output engine 218 including, without limitation, formatting instructions regarding a preferred length of the response, instructions regarding the tone of the response, instructions regarding the format of the response, instructions regarding prohibited words or phrases to be included in the response, context information that may be specific to the tenant or to the platform, and other predetermined instructions. In some cases, the predetermined prompt text includes a set of example input-output data pairs that may be used to provide example formatting, tone, and style of the expected generative response. In some cases, the predetermined prompt text includes special instructions to help prevent hallucinations in the response or other potential inaccuracies. The predetermined prompt text may also be pre-populated with exemplary content extracted from the platform's content item representing an ideal or reference output, which may reflect a style and tone of the tenant or content hosted on the platform.

In some implementations, the generative service 210 may also obtain or extract context data that is used to improve or further customize the prompt for a particular user, current session, or use history. In one example, the generative service 210 may obtain a user profile associated with an authenticated user operating the frontend that produced the user input. The user profile may include information about the user's role, job title, or content permissions classification, which may indicate the type of content that the user is likely to consume or produce. The role classification may be used to construct specific prompt language that is intended to tailor the generative response to the particular user. For example, for a user having a role or job title associated with a technical position, the generative service 210 may add text such as “provide an answer understandable to a level 1 engineer.” Similarly, for a user having a non-technical role or job title, the generative service 210 may add text to the prompt such as, “provide an answer understandable to a person without a technical background.” Additionally or alternatively, other context data may be obtained, which may be used to generate specific text designed to prompt a particular level of detail or tone of the generative response. Other context data includes content items that are currently or recently open in the current session, user event logs or other logs that indicate content that has been read or produced by the authenticated user, organizational information that indicates the authenticated user's supervisors and/or reporting employees and current role, and other similar context data. In some cases, a personalized query log is referenced, which includes the user's past queries or search history and an indication of successful (or non-responsive) results may be used as context data. Based on prior search results, the generative service 210 may be further supplemented to include language that improved past results or omit language that produced non-responsive or otherwise unsatisfactory results.

In some implementations, the generative service 210 may generate block-specific tags or text that is associated with each block of text inserted into the prompt. The tag may be a string of numbers and/or letters and may be used to identify the content item from which the block of text or segment of text was extracted. The tag may be an unassociated string of characters that does not inherently indicate a source of the text but can be used by the system, via a registry or some other reference object, to identify the source of the text. In other cases, the tag may include at least a portion of the content identifier, name of the content item, or other characters from which the source of the text can be directly inferred without a registry or reference object. In either configuration, the prompt may include predetermined prompt text that includes instructions for maintaining a record of tags which are used to generate the generative response. Accordingly, the generative service 210 may include a corresponding set of tags in the generative response that indicate which text blocks or snippets of text were used to generate the body of the generative response. This second set or corresponding set of tags may be used by the generative service 210 or other aspect of the system, to generate links, selectable icons, or other graphical objects that are presented to the user. Selection of the generated objects may cause a redirection of the graphical user interface to the respective content item, whether on the same platform or on a different platform. By using a tagging technique, the user may easily select a generated link in order to review the source material or to perform more extensive research into the subject matter of the generative response. If permitted by the generative output engine 218, reference to the content items (e.g., a URL or other addressable location) may be passed to the generative output engine 218 using the prompt and the prompt may include instructions to maintain or preserve the reference to the content items, which can be used to generate the links displayed in the interface with the generative response.

In accordance with other examples described herein, the prompt generated by the prompt service 214 may be communicated to the generative output engine 218 via a prompt management service 216 or prompt gateway. The prompt management service 216 may manage requests or input from multiple generative services in order to provide a single or shared gateway access to the generative output engine 218. In implementations in which the generative output engine 218 is an external service, the prompt may be communicated to the external generative output engine 218 using an application programming interface (API) call. In some cases, the prompt is provided to the generative output engine 218 using a JSON file format or other schema recognized by the generative output engine 218. If the generative output engine 218 is an integrated service, other techniques may be used to communicate the prompt to the generative output engine 218 as provided by the architecture of the platform including passing a reference or pointer to the prompt, writing the prompt to a designated location, or other similar internal data transfer techniques. As described throughout herein, the generative output engine 218 may include a large language model or other predictive engine that is adapted to produce or synthesize content in response to a given prompt. The generative response is unique to the prompt and different prompts, containing different prompt text, will result in a different generative response.

In response to the prompt, the generative output engine 218 sends a generative response to the issue generation service 220. The issue generation service 220 or a related service may perform post processing on the generative response including validation of the response, filtering operations to remove prohibited or non-preferred terms, elimination of potentially inaccurate phrases or terms, or performance of other post-processing operations. As discussed above, the issue generation service 220 may also process any tags or similar items returned in the generative response that indicate the source of content that was used for the generative response. The issue generation service 220 or a related service may generate links, icons, or other selectable objects to be rendered/displayed in a generative answer interface. Subsequent to any post-processing operations, the generative response, or portions thereof, are communicated to the frontend application for display in the generative answer interface. In some implementations, the issue generation service 220 may also receive express feedback provided via the interface regarding the suitability or accuracy of the results. The issue generation service 220 may also provide feedback that results from object selections, dwell time on the generative response, subsequent queries, and other user interaction events that may signal positive or negative feedback, which may be used to train intent recognition modules or other aspects of the system 200 to improve the accuracy and performance of subsequent responses.

In the present example the generative response and/or a postprocessed version of the generative response is passed back to the intake service 202, which may cause display of at least a portion of the generative response in the generative interface or other respective interface. In the example where the input is received via the chat service 208, the generative response may be displayed in a reply or message of the chat interface. In the example in which the user input is provided to a generative answer interface or generative interface, the response is displayed in a corresponding region of that interface.

The issue generation service 220 may also be configured to cause creation of one or more new issues at the issue tracking platform 206 using outputs from the generative output engine 218. For example, the issue generation system 220 may access a user account (e.g., from the intake service 202) and generate an issue creation request using issue data provide as part of the generative response. The issue creation request may use the user account as the requesting/generating user. In some cases, the issue generation service 220 can generate an issue-creation form and may configure a unique or distinct set of fields and selectable options used to create a specific type of issue adapted to handle a particular class of technical problem or task.

In some implementations, a portion of the generative response produced by the generative output engine 218 or the generative service 210 may be used to pre-populate at least a portion of the issue creation form. For example, a problem statement or description of the issue may be generated by the generative output engine 218 using extracted content and/or portions of the natural language user input, as described herein. The generative service may also cause portions of the issue creation form to be prepopulated with issue content or other content received in response to one or more content requests.

The issue generation service 220 or a related service may receive feedback or user validation from user accounts that are identified as having a subject matter expertise related to the generative response. The service or system may, in response to receiving positive feedback from an account flagged as having appropriate subject matter expertise (e.g., associated subject matter expertise has a threshold similarity to the subject matter of the generative response), the service or system may designate the generative response as verified or endorsed. In some cases, a graphical object corresponding to the verification or endorsement is displayed with the generative response in the corresponding interface. In some cases, verified or endorsed content is cached or saved and used for future responses or for use in subsequent prompts as an example input-output pair or as an exemplary response.

In some instances, the generative service 210 may include instructions to provide a confidence metric, such as a confidence interval or confidence score, with any generative response. The confidence metric may indicate an estimated confidence in the accuracy or relevance of the generative response. In response, the generative output engine 218, may provide the corresponding confidence metric along with the generative response. If the provided confidence metric falls below a threshold or fails to satisfy a confidence criteria, the generative service 210 may not cause the generative response to be displayed in the generative interface. In one example, a generative response having a confidence interval of less than 50% is not displayed. In some cases, a generative response having a confidence interval of less than 60% is not displayed. In some cases, a generative response having a confidence interval of less than 70% is not displayed. In some cases, a generative response having a confidence interval of less than 80% is not displayed. In some cases, the display of the response is suppressed or otherwise not displayed. In some cases, a message indicating that an answer or response is currently not available or other similar message may be displayed in the generative answer interface.

In general, the systems and techniques described herein, including the system 200 of FIG. 2, may include the use of data including potentially sensitive information including, for example, user generated content (UGC), personally identifiable information (PII), or potentially confidential information (also referred to herein as “potentially sensitive data”). The use of potentially sensitive data may be conducted in accordance with data privacy requirements as determined by local jurisdictions and the data policies of the respective companies for which the data is being handled. To the extent that the potentially sensitive data is managed by internal systems, appropriate safeguards and data protection techniques are employed including, but not limited to, restricting data access to authorized users, securing data storage, and other accepted data handling practices. For instances in which the potentially sensitive data is shared with third-party services or providers, the handling of the data may be performed in accordance with respective data privacy and data management requirements, company policies, and consent of the respective company and/or user.

In some implementations, the system may operate to remove potentially sensitive information, as necessary, from content (e.g., prompts) submitted to third-party services or providers including, for example a third-party generative output engine. Policies and practices can be adapted for the particular types of potentially sensitive information being collected and/or accessed and revised to adhere to applicable laws and standards, including jurisdiction-specific considerations. For example, the system may allow users to selectively block the use of, or access to, PII or other potentially sensitive data. The present disclosure contemplates that hardware and/or software elements can be provided to prevent or block access to such personal information data. For example, the present technology can be configured to allow authorized users to select to “opt in” or “opt out” of participation in the use of potentially sensitive information.

FIGS. 3A-3B depict system diagrams and network/communication architectures that may support a system as described herein. Referring to FIG. 3A, the system 300a includes a first set of host servers 302 associated with one or more software platform backends. These software platform backends can be communicably coupled to a second set of host servers 304 purpose configured to process requests and responses to and from one or more generative output engines 306.

Specifically, the first set of host servers 302 (which, as described above can include processors, memory, storage, network communications, and any other suitable physical hardware cooperating to instantiate software) can allocate certain resources to instantiate a first and second platform backend, such as a first platform backend 308 and a second platform backend 310. Each of these respective backends can be instantiated by cooperation of processing and memory resources associated to each respective backend. As illustrated, such dedicated resources are identified as the resource allocations 308a and the resource allocations 310a.

Each of these platform backends can be communicably coupled to an authentication gateway 312 configured to verify, by querying a permissions table, directory service, or other authentication system (represented by the database 312a) whether a particular request for generative response from a particular user is authorized. Specifically, the second platform backend 310 may be a documentation platform used by a user operating a frontend thereof.

The user may not have access to information stored in an issue tracking platform. In this example, if the user submits a request through the frontend of the documentation platform to the backend of the documentation platform that in any way references the issue tracking platform, the authentication gateway 312 can deny the request for insufficient permissions. This example is merely one and is not intended to be limiting; many possible authorization and authentication operations can be performed by the authentication gateway 312. The authentication gateway 312 may be supported by physical hardware resources, such as a processor and memory, represented by the resource allocations 312b.

Once the authentication gateway 312 determines that a request from a user of either platform is authorized to access data or resources implicated in service that request, the request may be passed to a security gateway 314, which may be a software instance supported by physical hardware identified in FIG. 3A as the resource allocations 314a. The security gateway 314 may be configured to determine whether the request itself conforms to one or more policies or rules (data and/or executable representations of which may be stored in a database 316) established by the organization. For example, the organization may prohibit executing prompts for offensive content, value-incompatible content, personally identifying information, health information, trade secret information, unreleased product information, secret project information, and the like. In other cases, a request may be denied by the security gateway 314 if the prompt requests beyond a threshold quantity of data.

Once a particular user-initiated prompt has been sufficiently authorized and cleared against organization-specific generative output rules, the request/prompt can be passed to a preconditioning and hydration service 318 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 318 can be a software instance supported by physical hardware represented by the resource allocations 318a. In some implementations, the hydration service 318 may also be used to rehydrate personally identifiable information (PII) or other potentially sensitive data that has been extracted from a request or data exchange in the system.

One a prompt has been modified, replaced, or hydrated by the preconditioning and hydration service 318, it may be passed to an output gateway 320 (also referred to as a continuation gateway or an output queue). The output gateway 320 may be responsible for enqueuing and/or ordering different requests from different users or different software platforms based on priority, time order, or other metrics. The output gateway 320 can also serve to meter requests to the generative output engines 306.

FIG. 3B depicts a functional system diagram of the system 300a depicted in FIG. 3A. In particular, the system 300b is configured to operate as a multiplatform prompt management service supporting and ordering requests from multiple users across multiple platforms. In particular, a user input 322 may be received at a platform frontend 324. The platform frontend 324 passes the input to a prompt management service 326 that formalizes a prompt suitable for input to a generative output engine 328, which in turn can provide its output to an output router 330 that may direct generative response to a suitable destination. For example, the output router 330 may execute API requests generated by the generative output engine 328, may submit text responses back to the platform frontend 324, may wrap a text output of the generative output engine 328 in an API request to update a backend of the platform associated with the platform frontend 324, or may perform other operations.

Specifically, the user input 322 (which may be an engagement with a button, typed text input, spoken input, chat box input, and the like) can be provided to a graphical user interface 332 of the platform frontend 324. The graphical user interface 332 can be communicably coupled to a security gateway 334 of the prompt management service 326 that may be configured to determine whether the user input 322 is authorized to execute and/or complies with organization-specific rules.

The security gateway 334 may provide output to a prompt selector 336 which can be configured to select a prompt template from a database of preconfigured prompts, templatized prompts, or engineered templatized prompts. Once the raw user input is transformed into a string prompt, the prompt may be provided as input to a request queue 338 that orders different user request for input from the generative output engine 328. Output of the request queue 338 can be provided as input to a prompt hydrator 340 configured to populate template fields, add context identifiers, supplement the prompt, and perform other normalization operations described herein. In other cases, the prompt hydrator 340 can be configured to segment a single prompt into multiple discrete requests, which may be interdependent or may be independent.

Thereafter, the modified prompt(s) can be provided as input to an output queue at 342 that may serve to meter inputs provided to the generative output engine 328.

These foregoing embodiments depicted in FIGS. 3A-3B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, although many constructions are possible, FIG. 4A depicts a simplified system diagram and data processing pipeline as described herein. The system 400a receives user input and constructs a prompt therefrom at operation 402. After constructing a suitable prompt, and populating template fields, selecting appropriate instructions and examples for an LLM to continue, the modified constructed prompt is provided as input to a generative output engine 404. A continuation from the generative output engine 404 is provided as input to a router 406 configured to classify the output of the generative output engine 404 as being directed to one or more destinations. For example, the router 406 may determine that a particular generative output is an API request that should be executed against a particular API (e.g., such as an API of a system or platform as described herein). In this example, the router 406 may direct the output to an API request handler 408. In another example, the router 406 may determine that the generative response may be suitably directed to a graphical user interface/frontend.

Another example architecture is shown in FIG. 4B, illustrating a system providing prompt management, and in particular multiplatform prompt management as a service. The system 400b is instantiated over cloud resources, which may be provisioned from a pool of resources in one or more locations (e.g., datacenters). In the illustrated embodiment, the provisioned resources are identified as the multi-platform host services 412.

The multi-platform host services 412 can receive input from one or more users in a variety of ways. For example, some users may provide input via an editor region 414 of a frontend, such as described above. Other users may provide input by engaging with other user interface elements 416 unrelated to common or shared features across multiple platforms. Specifically, the second user may provide input to the multi-platform host services 412 by engaging with one or more platform-specific user interface elements. In yet further examples, one or more frontends or backends can be configured to automatically generate one or more prompts for continuation by generative output engines as described herein. More generally, in many cases, user input may not be required, and prompts may be requested and/or engineered automatically.

The multi-platform host services 412 can include multiple software instances or microservices each configured to receive user inputs and/or proposed prompts and configured to provide, as output, an engineered prompt. In many cases, these instances—shown in the figure as the platform-specific prompt engineering services 418, 420—can be configured to wrap proposed prompts within engineered prompts retrieved from a database such as described above.

In many cases, the platform-specific prompt engineering services 418, 420 can each be configured to authenticate requests received from various sources. In other cases, requests from editor regions or other user interface elements of particular frontends can be first received by one or more authenticator instances, such as the authentication instances 422, 424. In other cases, a single centralized authentication service can provide authentication as a service to each request before it is forwarded to the platform-specific prompt engineering services 418, 420.

Once a prompt has been engineered/supplemented by one of the platform-specific prompt engineering services 418, 420, it may be passed to a request queue/API request handler 426 configured to generate an API request directed to a generative output engine 428 including appropriate API tokens and the engineered prompt as a portion of the body of the API request. In some cases, a service proxy can interpose the platform-specific prompt engineering services 418, 420 and the request queue/API request handler 426, so as to further modify or validate prompts prior to wrapping those prompts in an API call to the generative output engine 428 by the request queue/API request handler 426 although this is not required of all embodiments.

These foregoing embodiments depicted in FIGS. 3A-3B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative response may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative response provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

In some cases, a generative response, for example based on issue data from similar issued identified using semantic analysis, can be used to generate a user message for display in the intake portal graphical user interface using the received generative response. The user message can include a suggested action narrative and agent information. In some cases, the recommendation panel can include an option to cause the user message to be displayed in the intake portal graphical user interface. Accordingly, in response to an agent selection of the option the user message may be sent to the user via the intake portal graphical user interface.

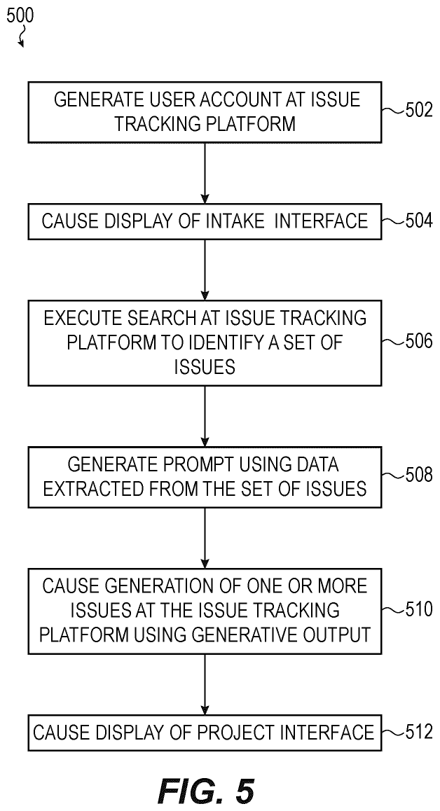

FIG. 5 depicts an example process 500 for using a generative output engine to generate a new set of issues as part of an account activation process, as described herein. The process 500 can be performed using the systems described herein (e.g., systems 100, 200, 300 and/or 400).

At operation 502, the process 500 includes generating a user account at an issue tracking platform. A user may establish login credentials and authenticate/validate the login credentials granting access to one or more services/features provided by the issue tracking platform. In some cases, a user may have established login credentials, for example, for other software services, and may authenticate/validate that their login credentials grant access to service/features of the issue tracking platform.

In some cases, in response to receiving user credentials (e.g., using a front-end application) the issue tracking platform obtains a user profile associated with an authenticated user operating the frontend. The user profile may include information about the user's role, job title, or content permissions classification, which may indicate the type of issues and/or content that the user is likely to consume or produce. The role classification may be used to configure the intake interface(s), generate one or more prompts, and/or used to tailor the generative response to the particular user account. Additionally or alternatively, other context data may be obtained, which may be used to generate specific text designed to prompt a particular level of detail or tone of the generative response. Other context data includes organizational information that indicates the authenticated user's supervisors and/or reporting employees and current role, and other similar context data.

At operation 504, the process 500 includes causing display of an intake interface. The issue tracking platform (e.g., issue tracking platform 206) and/or intake service (e.g., intake service 202) can cause display of the intake interface on a client device (e.g., a device used to establish the user account) in response to generating and/or authenticating the user account. The intake interface can be configured to collect information from a user that is used to generate a prompt for a generative output engine, and/or otherwise used to create a project and/or new issues for the user account.

In some cases, the intake interface (e.g., generated by intake service 202) can include a sequence of interfaces that are displayed according to a defined set of parameters. For example, a user input/response to a first interface can be used to select a second interface and/or select options displayed on the second interface. For example, a first interface may prompt a user to select a user role from a set of roles that are configured at the issue tracking platform. The issue tracking platform can be configured with multiple different user role types, which each define parameters for that role. The parameters may include a job function, business unit, hierarchical reporting relationship, technical level, and/or other information that is relevant to a specific role. Different role types may also be configured with different functionality of the issue tracking platform (e.g., different permissions, access to different types of data/issues, and so on), granted access to defined sets/types of projects/issue, and so on.

In some cases, a selection of the particular role can be used to determine what type of prompt and/or selection options are displayed on one or more subsequent intake interfaces. For example, in response to selection of a particular role, the issue tracking platform may access the defined set of parameters to generate a second intake interface. A second intake interface may include one or more selectable options each corresponding to a different project type classifier. Each project type classifier may be associated with different types of uses and define data and functions that are available to the particular user, and the issue tracking platform can be configured with multiple different types of project classifiers. The user role and the defined set of parameters may be used to select a subset of project classifiers within the second intake interface. A user may select or otherwise designate a project classifier from the defined set of project classifiers.

Additionally or alternatively, the intake interface can include interactive processes in which the information presented in the intake interface is generated using a generative output engine and based on user input to the intake interface (e.g., using intake interface 202, chat service 208, generative service 210 and/or the generative output engine 218). For example, the intake interface can include a text-based input field and may display questions that the user answers by inputting text into the text-based input field. In response to receiving text input to the text-based input field, the system can generate a prompt for submission to a generative output engine using the text input. A generative response from the generative output engine can be used to generate follow up questions for the user and additional prompts can be submitted to the generative output engine based on user input in response to the follow up questions.

The user input and/or generative responses can be analyzed and used to generate a search request (e.g., at operation 506) and/or a prompt (e.g., at operation 508), as described herein. In some cases, the system (e.g., generative service 210) may use a response from the generative output engine to determine when enough information has been collected for a user account as part of the intake process (e.g., via the intake interface). For example, one or more prompts may include instructions for the generative output engine to classify a user role, a project type classifier based on analyzing the text input and to return a confidence metric associated with each of these classifications. The system may be configured to determine when enough information is collected based on the confidence metrics satisfying a defined criteria. For example, once a classification metric from the user role satisfies a defined metric and/or a classification metric for a project type classifier satisfies a defined metric, the system may determine that enough information has been collected and proceed to the next operation.

At operation 506, the process 500 includes executing a search at the issue tracking platform to identify a set of issues managed by the issue tacking platform (e.g., via issue data service 204). As one example, the search includes submitting a search request to the issue tracking platform. The search request is generated using the project type classifier and the user role obtained using the intake interface. Additionally or alternatively, the system (e.g., the issue data service 204) can obtain additional information for one or more system, which may be used to generate the search request. For example, the issue data service may access other systems such as a user data service, which includes permissions for a particular user and/or role assigned to that user, teams the particular user account is associated with, and so on.

In some cases, the search request can be a structured search request and include a set of parameters that is configured to return issues from other users of the system that have a similar role, similar project types and so on. Accordingly, the search can return a set of issues that are representative of the projected use for the user. In some cases, a semantic analysis can be performed (e.g., by issue data service 204 and/or generative service 210) on results returned from the issue tracking platform (e.g., issue tracking platform 206) and the semantic search can be used to identify a subset of issues that are used to generate the prompt (e.g., at operation 508).

At operation 508, the process 500 includes generating a prompt using data extracted from the set of issues identified from the search request and returned from the issue tracking platform. In some cases, the system (e.g., issue data service 204 and/or generative service 210) can be configured to analyze the set of issues to extract particular information from the set of issues. For example, the data extracted from the set of issues can include, for each issue, a respective title, a respective issue description, a respective defined project workflow, one or more hierarchical relationships, or combinations thereof. Additionally or alternatively, the issue data can include metrics associated with current or pending issues such as compliance with one or more SLAs, timing of issue state transitions, different user accounts/user roles associated with a respective issue, completion timing, and so on.

In some cases, the system may be configured to select a predetermined number of issues from the returned set of issues for inclusion in the prompt. The system may use a semantic search based on the user role, the project type classifier, or other information submitted by the user to the intake portal to identify (e.g., collectively “intake data”), which issues to be included in the prompt. For example, the semantic search may return a similarity score of each issue to the intake data used to generate a sematic search and select the issues having the highest similarity score.

The prompt can include predetermined prompt language that provides instructions for the generative output engine and the selected data corresponding to the set of issues. The instructions can be configured to cause the generative output engine to provide a generative response that includes new issue data and a particular format for that issue data. For example, the prompt can include instructions to generate a new project including a set of hierarchical defined issues for the new user account based on the set of issues, the user role and/or the project classifier. In some cases, the prompt instructions can define a role/persona that the generative output engine will take on (e.g., act as an issue tracking platform project generator), define parameters specifying a number and hierarchy of the project and issues to be created (e.g., generate a maximum of three projects each having a maximum of four dependent issues), and so on.

The prompt can also be configured with instructions to generate at least a portion of the generative response as a structured data format. For example, the prompt may specify that the project(s) and the respective dependent issues are formatted in accordance with a particular structured data format. In some cases, the prompt can include pre-determined prompt text that includes instructions/commands (e.g., a formatting command) to generate and format data included in a generative response. For example, the pre-determined prompt text provides an example of a structured data format (e.g., JSON object) and example data fields that can be generated in accordance with the structed data format. In some cases, the instructions may include an identification of data fields in the data extracted from the set of issues and include instructions to generate new/original data fields for the new set of issues using the example data and output the newly generated data in the structured format. Accordingly, at least a portion of the generative response can include the new issue data formatted according to the instructed structured data format. The system can be configured to process the generative response to identify and extract the structured data and generated inputs to the issue tracking system to produce the new issues and/or project. For example, the system (e.g., generative service 210) and/or the issue generation service can identify a JSON-formatted data structure in the generative response and use that data to generate one or more new issues requests to the issue tracking system. In some cases, data from the structured data format (e.g., JSON formatted data structure) can be used to fill in or generate fields for an issue intake/generation request used by the issue tracking system to generate new issues.

At operation 510, the process 500 includes causing generation of one or more issues at the issue tracking platform using a generative response from a generative output engine. For example, the issue generation service 220 can analyze the generative response to identify the one or more projects and issues and corresponding issue data from the structure data format output from the generative output engine. For example, the issue generation service 220 may use elements of the generative response, in the structured data format (e.g., JSON format) and generate an issue object that has elements/data fields corresponding to the structed data in the structured data output (e.g., JSON formatted data in the generative output). The issue generation service can cause generation of the projects and one or more issues at the issue tracking platform. For example, the issue generation service may submit one or more requests, on behalf of the user account, to the issue tracking platform to cause the issue tracking platform to generate the new issues and/or projects for the user account.

The request to generate the new projects/issues can include issue data generated by the generative output engine and provided in the generative response. The issue generation service can extract the issue data from the structured data format of the generative response. The issue data (e.g., stored according to a requested structured data format) can include parameters for a respective project and/or issues including an issue title, issue descriptions, hierarchical/dependent relationships to other issues, timing (e.g., deadlines, SLAs, etc.) for each respective issue, workflows, automations and/or respective trigger conditions. For example, in some cases, the structured data output (e.g., based on the formatting instructions/command in the prompt) can define hierarchical relationships (e.g., parent-child, depends on, depends from, block-by or other types of hierarchical and/or dependent relationships) between different issues that are defined by the generative response. The prompt instructions can provide examples of hierarchical dependencies, and cause the generative output engine to define hieratical dependencies for the newly generated issues which can be stored/defined in the structured data portion of the generative output.

At operation 512, the process 500 includes causing display of a project interface on a client device. For example, in response to submitting the request to create the new projects and/or issues at the issue tracking platform and/or confirmation from the issue tracking platform confirming creation of the new issues, the system can be configured to cause display of a project creation interface at the client device. The project creation interface can be managed by the issue tracking platform. In some cases, the system can select different instances of the issue tracking platform based on the user role and/or other information associated with the user account. For example, in response to the user account being associated with a first type of role, the system can create issues at and launch a first instance of the issue tracking platform that is configured with particular functionality (e.g., an instance of the issue tracking platform configured for software development). In response to the user account being associated with a second type of role, the system can create issues at and launch a second instance of the issue tracking platform that is configured with a second particular functionality (e.g., instance of the issue tracking platform configured for project management).

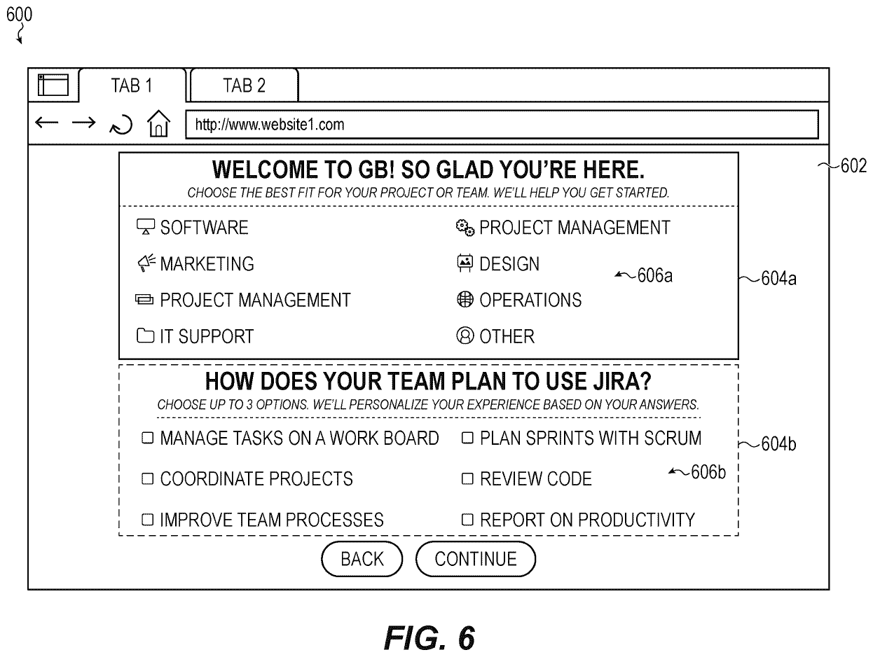

FIG. 6 depicts an example intake interface 600 that can be used for generating a new set of issues at an issue tracking platform. The intake interface 600 can be displayed by the systems described herein and on a client device as part of an account generation process, as described herein. The interface 600 can include a content region 602 that provides an example of a series of interfaces 604 that include selectable options 606 for collecting information and associating that information with a user account, as described herein. The series of interfaces 604 and selectable options 606 can be displayed according to a defined set of parameters, as described herein.

In some cases, the intake interface 600 can include a first interface 604a that includes a first set of selectable options 606a. The first set of selectable options 606a can be displayed according to the defined set of parameters, and in this case include options related to a user role. In response to detecting a selection of a particular selectable option 606a from the client device, the system can cause display of a second interface 604b that includes a second set of selectable options 606b. The second interface 604b can be displayed simultaneously with the first interface 604a, and changes to selection of a selectable option of the first interface 604a can cause the selectable options at the second interface 604b to be updated in accordance with the defined set of parameters. In other cases, the intake interface 600 can be updated to replace the first interface 604a with the second interface 604b.

The defined set of parameters can define a sequence of interfaces 604 that are displayed and define which selectable options are displayed. For example, in response to selecting a “SOFTWARE” selectable option from the first set of selectable options 606a, the defined set of parameters can be accessed by the system to determine which options should be displayed in the second interface 604b. Accordingly, the defined set of parameters may define multiple different sequences of interfaces that are displayed on the client device and used to obtain information for a new user account. Accordingly, in this example, the sequence of interface, number of interface, and selectable options can be displayed in accordance with the defined set of parameters.

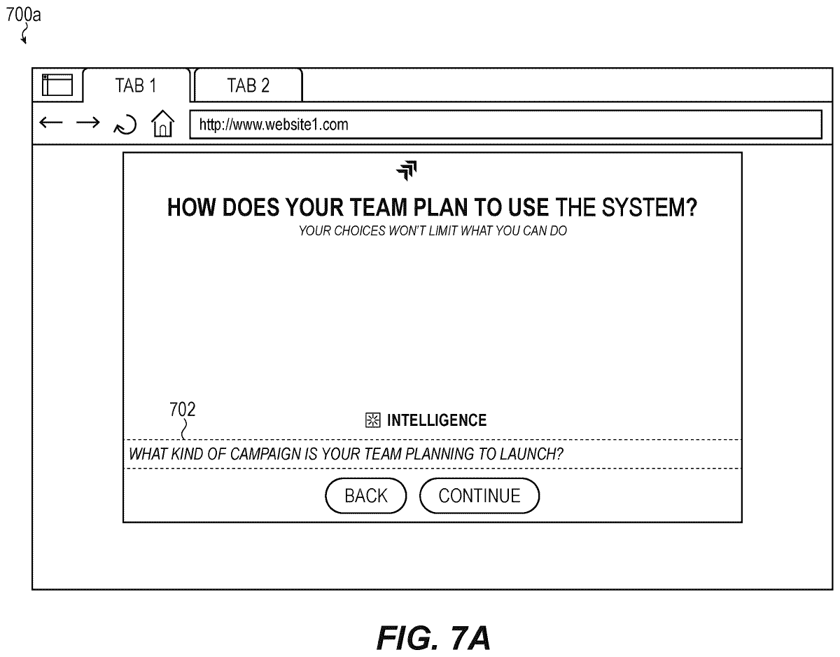

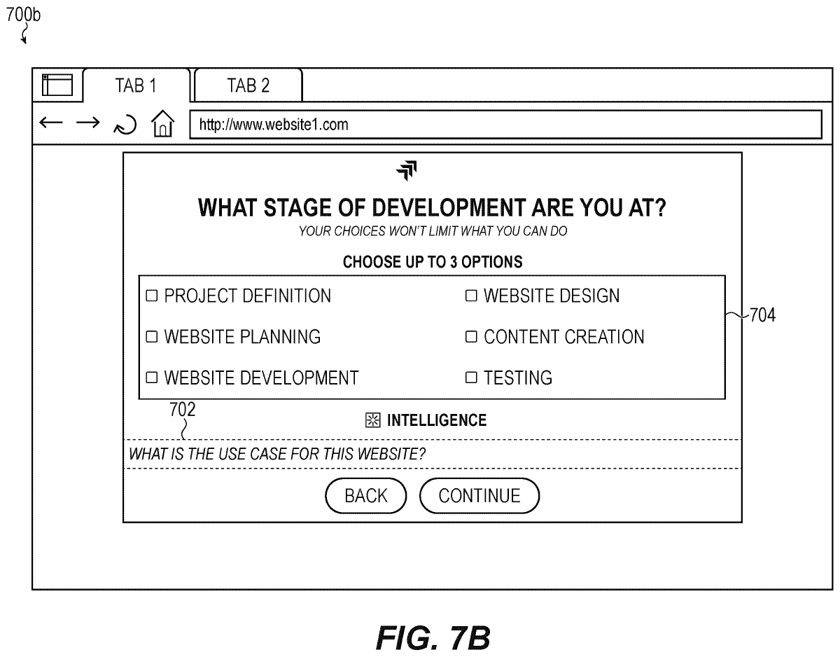

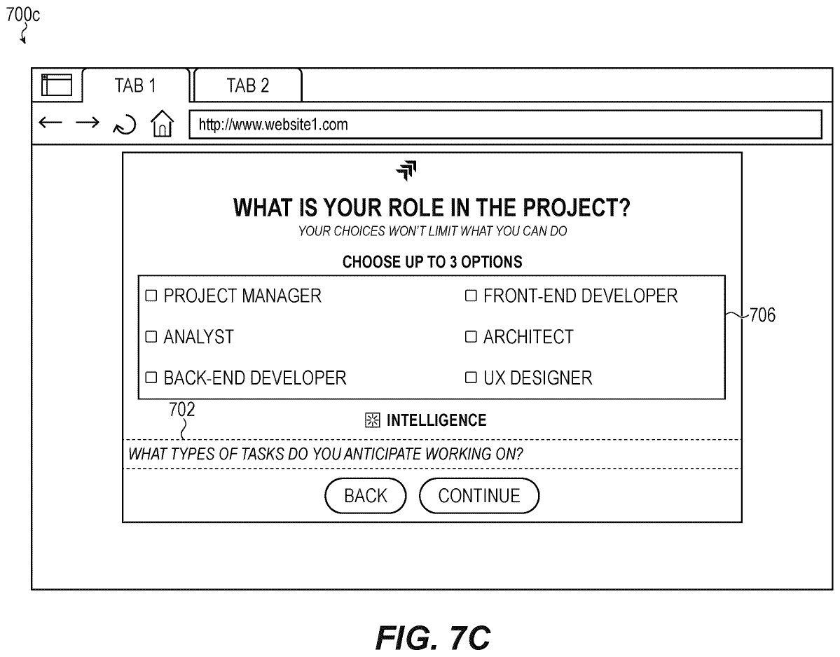

FIGS. 7A-7C depict an example intake interface 700 for generating a new set of issues at an issue tracking platform. FIGS. 7A-7C display an example series of interfaces that are configured as an interactive process in which the information presented in the intake interface is generated using a generative output engine and based on user input to the intake interface 700. For example, the intake interface 700 can include a text-based input field 702 and may display a questions that the user answers by inputting text into the text-based input field 702. In response to receiving text input to the text-based input field, the system can generate a prompt for submission to a generative output engine using the text input. A generative response from the generative output engine can be used to generate follow up questions for the user and additional prompts can be submitted to the generative output engine based on user input in response to the follow up questions.

FIG. 7A provides an example of a first interface 700a that includes a first question (e.g., “How Does Your Team Plan to Use Jira?”) that is configured to solicit a particular response. The first interface 700a includes the text-based input field 702 and in response to user input to the text-based input field the system can be configured to generate and submit a prompt to a generative output engine. The prompt can include instructions for the generative output engine and the user input text. In some cases, the instructions can include directions for analyzing the user input text and a desired output. For example, the output may include a follow up question for obtaining additional information.

FIG. 7B provides an example of a second interface 700b that includes a second question (e.g., “What Stage of Development are You At?”), which can be based on an output from the generative output engine in response to the first text input from the user. The second interface 700b can include the text-based input field 702, which is configured to receive user input and generate a prompt to the generative output engine, as described herein (e.g., with respect to operation 508 of process 500). Additionally or alternatively, the second interface 700b can include a set of selectable options 704, which can be based on the first generative response. A selection of one or more of the selectable options 704 can be used to generate the prompt.

FIG. 7C provides an example of a third interface 700c that includes a third question (e.g., “What is Your Role in the Project?”) which can be based on the first and/or second generative response generated in response to user inputs to the first interface 700a and/or the second interface 700b. The third interface 700c can include the text-based input field 702, which is configured to receive user input and generate a prompt to the generative output engine. Additionally or alternatively, the third interface 700c can include a set of selectable options 706, which can be based on the first generative response and/or the second generative response. A selection of one or more of the selectable options 706 can be used to generate the prompt.

In some cases, the system can be configured to iteratively display an interface that is configured to receive user input, evaluate that input and determine if additional user input should be collected (e.g., via one or more additional interfaces). In some cases, the system may use a sufficiency criteria to determine when enough information has been collected. In some cases, the system can include one or more defined sequences of questions. In these examples, a sufficiency criteria can be satisfied when a user has provided input in response to each interface generated in accordance with a defined sequence. In other cases, the system may be configured to evaluate user input to determine when a sufficiency criteria is satisfied. For example, in response to a user inputting text-based input, the system may evaluate whether the input can be used to select a project classifier (e.g., using semantic analysis to match the input to a particular project type classifier). In response to determining that a match to a particular project classifier satisfies a criteria, the system may be configured to associate that project classifier with the account generation process and determine that the sufficiency criteria has been satisfied.

In some cases, the system may utilize a generative output engine to determine a sufficiency criteria based on user inputs. For example, the system may be configured generate a prompt that includes an exemplary data set in which user input to the generative interface can be compared by a generative output engine. For example, each time a user input is received at the generative interface, the system may generate a prompt that include the received input (and already received user input, if any), the exemplary data set, and instructions for the generative output engine to output a sufficiency score based on comparing the received user input to the exemplary input. The sufficiency score, output by the generative output engine, can be compare to a defined criteria. In response to determining that the sufficiency score satisfying the defined criteria, the system can be configured to determine that enough information has been received from the user and proceed to generating a search request. In response to determining that the efficiency score does not satisfy the defined criteria, the system can cause generation and display of additional intake interfaces with additional questions or selection options and collect additional inputs, determine an updated sufficiency score based on the additional inputs. Such process may repeat, until an outputted sufficiency score satisfies the defined criteria.

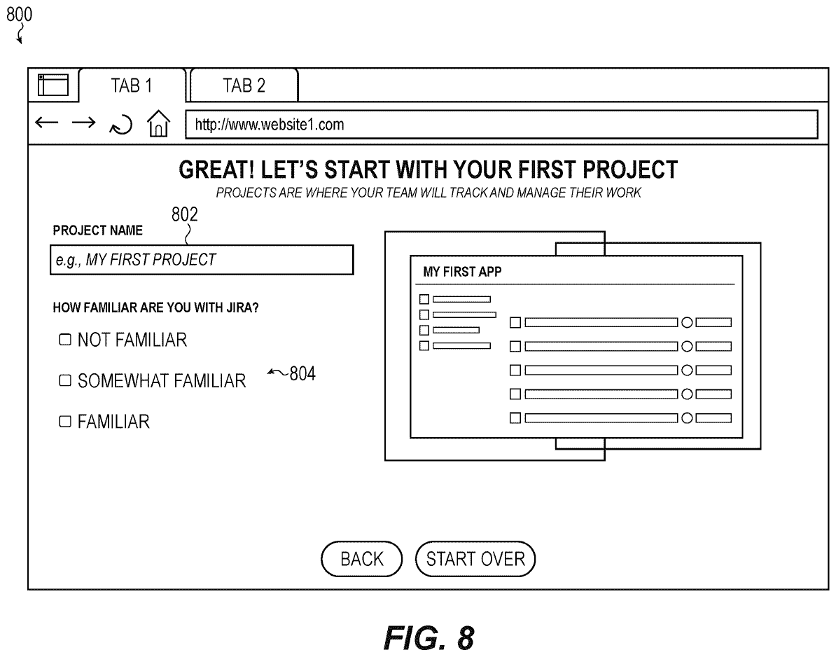

FIG. 8 depicts an example intake interface 800 for generating a new set of issues at an issue tracking platform. The interface 800 can be displayed as part of the intake process and in response to completing collection of use information from a user (e.g., using intake interfaces 600 and 700). The interface 800 can be configured to receive user input specifying one or more project names, which, in turn, can be used to generate the new projects/issues, as described herein. In some cases, the intake interface 800 can include a text-based input field 802, which can be used to receive user input specifying a project name.

Additionally or alternatively, the intake interface 800 may include additional options, which can be used to generate the new project(s) and issues using a generative output engine, as described herein. For example, the intake interface 800 can include selectable options 804, which in this example, specify an experience level for the issue tracking platform. A selection of one of these options can be used to generate the prompt for creating the new project and/or issues. For example, the instructions in the prompt can include instructions to generate a project and issues for a user with a specific amount of experience. Additionally or alternatively, a selection of one of the options 804 can be used to generate search parameters for retrieving the set of issues from the issue tracking platform and that are included in the prompt, as described herein. For example, the search parameters can include retrieving issues that are associated with other user accounts that have a similar experience level. For example, the search parameters may define an experience level for searching similar issues at the issue tracking platform.

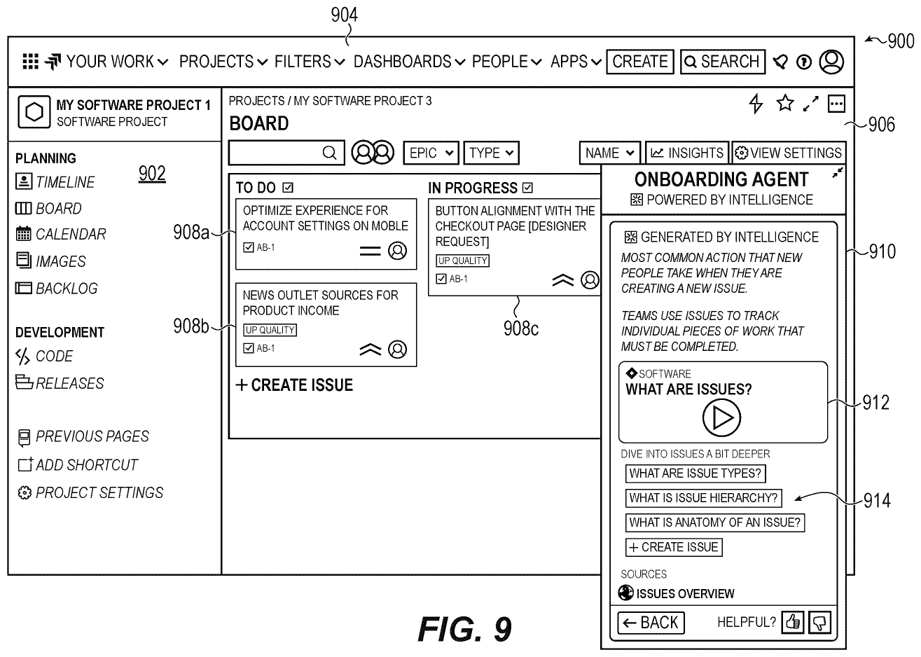

FIG. 9 depicts an example project interface 900 including a new project having a set of issues 908 generated using a generative output engine as part of an account activation process, as described herein. The example project interface 900 can be an example of the graphical user interfaces described herein. In some cases, the project interface 900 can have various partitions/sections displaying different content. For example, the project interface 900 may include a navigational panel 902, a toolbar 904, and a dashboard data panel 906.

The navigational panel 902 may include a hierarchical element tree (also referred to as issue groups or issues), which may be associated with particular issues, one or more issue queues, and/or one or more particular projects, which may be used to manage a set of issues. The hierarchical element tree includes tree elements which may be selectable to cause display of a corresponding issue, or other function provided by the issue tracking platform. Tree elements may also be referred to herein as selectable elements. Each tree element for the hierarchical element tree may be selectable. In response to a user selection of a respective element of the hierarchical element tree, content of the respective issue or function may be displayed in the dashboard data panel 906. In some cases, display of the navigational panel 902 may be suppressed or hidden using a control provided in the project interface 900. Additionally or alternatively, the navigational panel 902 may be resized or dragged all the way to the side of the project interface in order to hide or suppress display of the navigational panel 902.

The toolbar 904 may provide various control options to a user including, but not limited to, setting or configuring various restrictions for the issue, queuing, and/or projecting issues to view or review. The toolbar 904 may also include a search or query space for the user to enter one or more keywords to perform a search for issues, queues, projects or content that may be managed by the issue tracking platform. The toolbar 904 may also include options for selecting a different project, viewing recently viewed issues or queues, viewing people associated with the system or respective content, navigating or launching other applications, or viewing other aspects of the system. The toolbar 904 may include an option to create elements for initiating the creation of issues in the issue tracking platform.

The dashboard data panel 906 can include a project view of issues managed by the issue tracking platform. The dashboard panel 906 can display multiple issues 908 arranged according to various definitions. For example, the dashboard data panel 906 shown in FIG. 9 provides an example of issues 908 arranged according to a status associated with the issue 908. For example, the new set of issues can include a first issue 908a, a second issue 908b and a third issue 908c. As issues progress to different stages, the system may update/change a location of the issue object within the dashboard panel 906.

In some cases, the project interface 900 can include an interactive onboarding interface 910, which is configured to provide support as part of the account activation process. The interactive onboarding interface can be supported by a generative output engine and configured to display and update content based on information that is obtained as part of the intake process (e.g., using the intake interfaces described herein) and/or based on user interactions with the project interface 900. In some cases, the project interface 900 can include resource 912 that provides information specific to the user and/or can include selectable elements 914, which may be used to generate additional resource or otherwise provide information to the user.

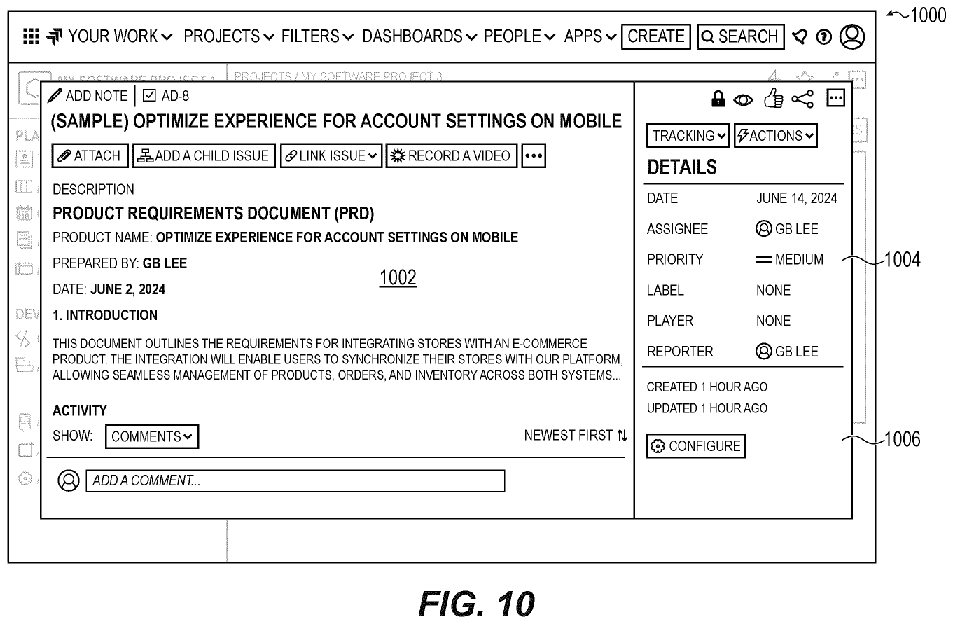

FIG. 10 depicts an example issue view interface 1000 for an issue generated using a generative output engine, as described herein. For example, the interface 1000 can display an issue view for the first issue 908a. For example, issue data may be displayed in a first display area 1002. In some cases, users (e.g., agents, administrators) may edit these fields as more information is received. In some cases, the intake interfaces may include hidden fields. These hidden fields may be displayed to users in the first display area 1002.

The issue tracking platform may store or track the issue creation form that was used to create respective issues or tickets. The request type issue creation form that was used to create the issue may be stored as a form identifier (form ID) and associated with the issue or ticket in the issue tracking platform. The issue tracking platform or the issue tracking portal may also gather other data (e.g., from user event logs or databases coupled to the issue tracking platform), including similar requests and activity. In many cases, enterprises use a service-level agreement (SLA), which specifies the processes, timelines, and metrics by which services, such as IT, are provided. The issue tracking platform may include issue item metric regions, such as regions 1004 and 1006, which may track metrics according to an SLA. For example, upon generating an issue item, the issue tracking platform may automatically set a time for reply and completion that may correspond to an SLA. Similarly, region 1006 may include editable field items that may be used to resolve the issue. For example, an issue item may be assigned to particular service agents, the urgency of the request may be set, and the like. The issue tracking platform may also include other fields which may be used by service agents to track metrics, add labels, track time, and the like.

The issue tracking platform may process each of the issues or tickets in accordance with a workflow or series of predefined states that the issue must traverse in order to be resolved by the issue tracking platform. When an issue is created using a particular request type, a workflow for resolving the issue is generated (e.g., via a backend application of the service management portal, such as the issue tracking platform). As a first step, the issue may be assigned to a service agent or other user. In some embodiments, the request type and/or other fields from the intake interface may determine the assignment step. For example, a group of users may be assigned to particular intake categories. As another example, a group of users may be assigned to a project where a particular request type can be used. As yet another example, a particular data input to a field may determine a user or a group of users to be assigned to the issue.

Once an issue item is created and assigned, the user or group of users assigned to the item may review the issue. On review of the issue, the assigned users may resolve the issue or may transfer the issue, as an example. Upon transferring, updated assignees may review the issue again to ensure proper routing of the issue item. In some cases, the issue may be reassigned to a different intake type, canceled or it may be linked to another issue for a combined resolution. In some cases, depending on the complexity and/or the type of request, the workflow may include additional steps or less steps. More generally, the request type may dictate the number of steps and workflow used for each of the issue items. Accordingly, building an intake interface request type may determine the fields displayed to a help desk, the fields visible in the issue tracking platform, and the workflow associated with the issue item.

The issue data stored in association with a form identifier or form ID and associated with the issue or ticket in the issue tracking platform can be used to generate a suggested new request type as described herein. The issue data may be extracted from issues to determine whether to generate a prompt and/or be provided as input to a generative output system as part of the prompt. For example, issue data such as a description, SLA compliance, title, issue activity, messages, and/or request types associated with a form of a particular issue can be extracted and used in a clustering analysis to determine whether an activity criteria is satisfied, provided to a generative output engine as part of a prompt, in generating a new request type interface/forms as described herein. The issue tracking platform or the issue tracking platform may also gather other data (e.g., from user event logs or databases coupled to the issue tracking platform), including similar requests and activity and utilize this data as part of generating a suggested new request type.

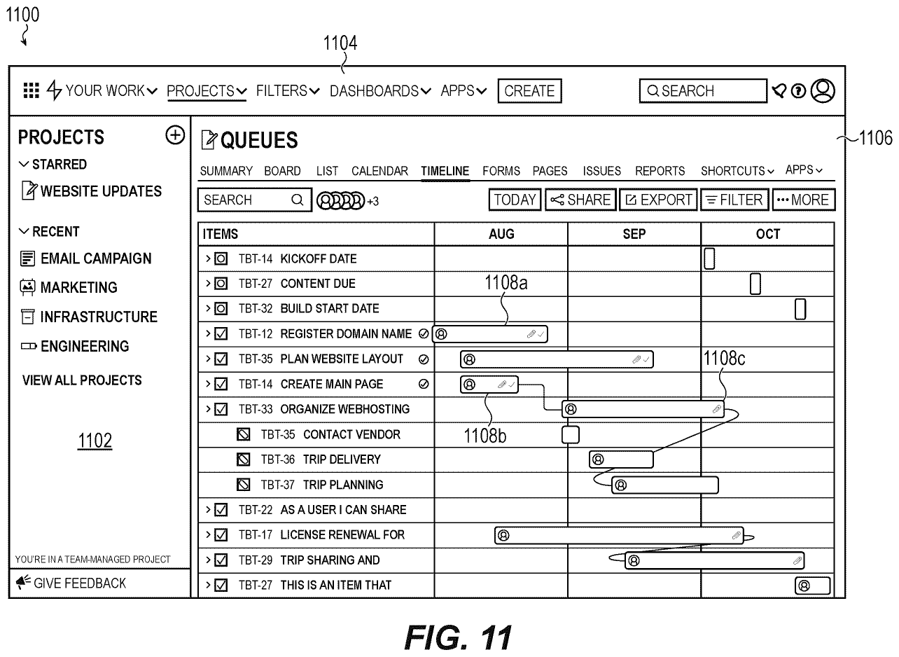

FIG. 11 depicts an example project interface 1100 including issue objects 1108 corresponding to a new set of issues generated using a generative output engine as part of an account activation process. The example project interface 1100 can be an example of the graphical user interfaces described herein. In some cases, the project interface 1100 can have various partitions/sections displaying different content. For example, the project interface 1100 may include a navigational panel 1102, a toolbar 1104, and a dashboard data panel 1106. In the illustrated example, the dashboard panel 1106 can display a dependency view of the new issues generated as part of the intake process and using the generative output engine as described herein.

The example project interface 1100 shown in FIG. 11 arranges issues according to timeline and hierarchy dependency based on issue data associated with each issue. For example, the location of and configuration (e.g., size, appearance, etc.) of a first issue object 1108a may be determined from issue data associated with that object. The location may be based on the dependency or timing (e.g., planned start date, SLA, etc.) associated with the issue and the size (e.g., length) of the first issue object 1108a can be used to indicate a timeframe associated with the corresponding issue.

The project interface 1100 can display issue objects for issues that are all related to a common project. The project can include issues that have hierarchical dependencies. For example, the project can include a second issue object 1108b (corresponding to a second new issue generated as part of the account generation process described herein) and a third issue object 1108c (corresponding to a third new issue generated as part of the account generation process described herein). The project interface 1100 may include a connector that indicates a hierarchical dependency defined by the second new issue and/or third new issue. For example, the third issue may be dependent on the second issue and therefore the second issue needs to be complete before progressing to the third new issue. Accordingly, the second issue object 1108b can display a connector to the third issue object 1108c indicating this dependency. The project may include additional new issues that were generated as part of the account generation process described herein having other dependencies. The new issues may all depend from a common issue, which may be a data structure that stores/defines the project within the issue tracking platform. For example, the project may have a title and be defined by the subset dependent issues that depend from the project issue.

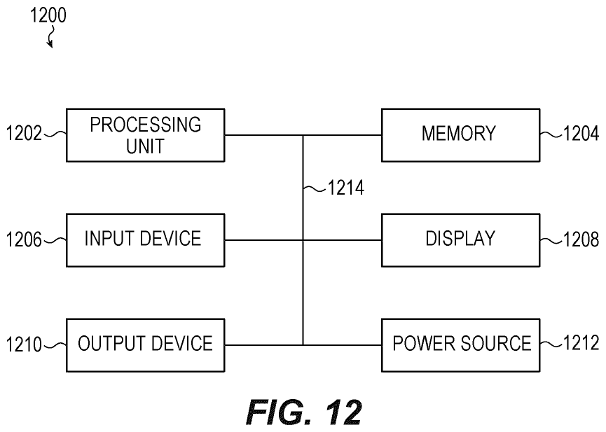

FIG. 12 shows a sample electrical block diagram of an electronic device 1200 that may perform the operations described herein. The electronic device 1200 may in some cases take the form of any of the electronic devices described with reference to FIGS. 1-11 including client devices, and/or servers or other computing devices associated with the issue tracking platform. The electronic device 1200 can include one or more of a processing unit 1202, a memory 1204 or storage device, input devices 1206, a display 1208, output devices 1210, and a power source 1212. In some cases, various implementations of the electronic device 1200 may lack some or all of these components and/or include additional or alternative components.

The processing unit 1202 can control some or all of the operations of the electronic device 1200. The processing unit 1202 can communicate, either directly or indirectly, with some or all of the components of the electronic device 1200. For example, a system bus or other communication mechanism 1214 can provide communication between the processing unit 1202, the power source 1212, the memory 1204, the input devices 1206, and the output devices 1210.

The processing unit 1202 can be implemented as any electronic device capable of processing, receiving, or transmitting data or instructions. For example, the processing unit 1202 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1200 can be controlled by multiple processing units. For example, select components of the electronic device 1200 (e.g., an input device 1206) may be controlled by a first processing unit and other components of the electronic device 1200 (e.g., the display 1208) may be controlled by a second processing unit, where the first and second processing units may or may not be in communication with each other.

The power source 1212 can be implemented with any device capable of providing energy to the electronic device 1200. For example, the power source 1212 may be one or more batteries or rechargeable batteries. Additionally, or alternatively, the power source 1212 can be a power connector or power cord that connects the electronic device 1200 to another power source, such as a wall outlet.

The memory 1204 can store electronic data that can be used by the electronic device 1200. For example, the memory 1204 can store electronic data or content such as, for example, audio and video files, documents and applications, device settings and user preferences, timing signals, control signals, and data structures or databases. The memory 1204 can be configured as any type of memory. By way of example only, the memory 1204 can be implemented as random access memory, read-only memory, flash memory, removable memory, other types of storage elements, or combinations of such devices.

In various embodiments, the display 1208 provides a graphical output, for example associated with an operating system, user interface, and/or applications of the electronic device 1200 (e.g., a chat user interface, an issue-tracking user interface, an issue-discovery user interface, etc.). In one embodiment, the display 1208 includes one or more sensors and is configured as a touch-sensitive (e.g., single-touch, multi-touch) and/or force-sensitive display to receive inputs from a user. For example, the display 1208 may be integrated with a touch sensor (e.g., a capacitive touch sensor) and/or a force sensor to provide a touch-and/or force-sensitive display. The display 1208 is operably coupled to the processing unit 1202 of the electronic device 1200.

The display 1208 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1208 is positioned beneath and viewable through a cover that forms at least a portion of an enclosure of the electronic device 1200.

In various embodiments, the input devices 1206 may include any suitable components for detecting inputs. Examples of input devices 1206 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1206 may be configured to detect one or more particular types of input and provide a signal (e.g., an input signal) corresponding to the detected input. The signal may be provided, for example, to the processing unit 1202.

As discussed above, in some cases, the input devices 1206 include a touch sensor (e.g., a capacitive touch sensor) integrated with the display 1208 to provide a touch-sensitive display. Similarly, in some cases, the input devices 1206 include a force sensor (e.g., a capacitive force sensor) integrated with the display 1208 to provide a force-sensitive display.

The output devices 1210 may include any suitable components for providing outputs. Examples of output devices 1210 include light emitters, audio output devices (e.g., speakers), visual output devices (e.g., lights or displays), tactile output devices (e.g., haptic output devices), communication devices (e.g., wired, or wireless communication devices), and so on, or some combination thereof. Each output device 1210 may be configured to receive one or more signals (e.g., an output signal provided by the processing unit 1202) and provide an output corresponding to the signal.

In some cases, input devices 1206 and output devices 1210 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1202 may be operably coupled to the input devices 1206 and the output devices 1210. The processing unit 1202 may be adapted to exchange signals with the input devices 1206 and the output devices 1210. For example, the processing unit 1202 may receive an input signal from an input device 1206 that corresponds to an input detected by the input device 1206. The processing unit 1202 may interpret the received input signal to determine whether to provide and/or change one or more outputs in response to the input signal. The processing unit 1202 may then send an output signal to one or more of the output devices 1210, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, which are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

It is the intent of the present disclosure that data including potentially sensitive information including user-generated content, personal identifiable information, and potentially confidential information (also referred to herein as “potentially sensitive data”) should be managed and handled in a way to minimize risks of unintentional or unauthorized access or use. Risk can be minimized by limiting the collection of data and deleting data once it is no longer needed. Therefore, although the present disclosure broadly covers use of data that may include potentially sensitive information to implement one or more various disclosed embodiments, the present disclosure also contemplates that the various embodiments can also be implemented with informed consent, measure for reducing exposure of potentially sensitive data, and/or without the need for accessing such potentially sensitive data.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed only for legitimate, agreed-upon, and reasonable uses.

What is claimed is:

1. A method for generating a set of issues for an issue tracking platform, the method comprising:
in response to a request from a client device, generating a user account at the issue tracking platform;
in response to generating the user account, causing display of an intake interface on the client device;
in response to receiving user input at the intake interface, analyzing the user input to determine a project type classifier;
executing a search at the issue tracking platform to identify a set of issues managed by the issue tracking platform, the search comprising search parameters generated using data extracted from analyzing the user input:
causing generation of a prompt comprising:
predetermined prompt language selected based on the project type classifier; and
data extracted from the set of issues;
in response to receiving a generative response from a generative output engine, the generative response produced in response to the generative output engine receiving the prompt;
analyzing the generative response to identify a first portion of the generative response corresponding to a project definition and a second portion of the generative response corresponding to one or more issues;
causing generation of a project comprising the one or more issues hierarchically arranged within the project; and
causing display of a project interface comprising one or more graphical objects, each corresponding to an issue of the one or more issues.

2. The method of claim 1, wherein:
the prompt is a first prompt and the generative response is a first generative response;
the intake interface comprises a text-based input field;
in response to receiving text input to the text-based input field, generating a second prompt for submission to the generative output engine, the second prompt including the text input; and
the search at the issue tracking platform is generated using a second generative response from the generative output engine received in response to providing the second prompt to the generative output engine.

3. The method of claim 2, wherein:
the user input further comprises a user role; and
the search at the issue tracking platform is executed using the project type classifier and the user role.

4. The method of claim 1, wherein the data extracted from the set of issues comprises, for each issue of the set of issues, a respective title, a respective issue description, a respective defined project workflow, one or more hierarchical relationships, or combinations thereof.

5. The method of claim 1, wherein:
the intake interface comprises a sequence of interfaces that are selected according to a defined set of parameters;
each interface of the sequence of interfaces comprises a set of options displayed in accordance with the defined set of parameters; and
a selected option for a currently displayed interface of the sequence of interfaces is used to select a subsequent set of options displayed in a subsequent interface.

6. The method of claim 1, wherein the predetermined prompt language comprises instructions to generate at least a portion of the generative response in a structured data format.

7. The method of claim 6, wherein analyzing the generative response comprises identifying the one or more issues and corresponding issue data from the structure data format.

8. The method of claim 7, wherein:
causing generation of the project comprises causing generation of the one or more issues at the issue tracking platform, the one or more issues associated with the user account; and
the one or more issues are processed in accordance with an issue workflow.

9. A method for generating example issues for an issue tracking platform, the method comprising:
receiving a request to generate a user account at the issue tracking platform;
in response to the receiving the request, causing display of an intake interface comprising a first set of selectable options;
in response to detecting a selection of a first selectable option from the first set of selectable options, causing display of a second set of selectable options at the intake interface, the second set of selectable options determined using the first selectable option and a defined set of parameters;
in response to detecting a selection of a second selectable option from the second set of selectable options, executing a structured search request on the issue tracking platform, the structured search request generated using data determined from the first selectable option and the second selectable option;
subsequent to receiving a set of issues in response to executing the structured search request:
causing generation of a prompt comprising:
issue data extracted from the set of issues; and
prompt text including a command to generate new issue data for one or more new issues and a formatting command;
providing the prompt to a generative output engine;
receiving a generative response from the generative output engine, the generative response produced by the generative output engine in response to the prompt and formatted in accordance with the formatting command;
analyzing the generative response to identify a plurality of issue data sets;
subsequent to identifying the plurality of issue data sets, causing creation of a project and causing creation of a set of new issues, the set of new issues assigned to the project and including data extracted from the plurality of issue data sets; and
causing display of a project interface comprising issue objects based on the set of new issues.

10. The method of claim 9, wherein:
the set of new issues is associated with the user account; and
the set of new issues is processed in accordance with an issue workflow defined for each issue of the set of new issues.

11. The method of claim 9, wherein the plurality of issue data sets comprise, for each issue of the set of new issues, a respective title, a respective issue description, a respective defined project workflow, one or more hierarchical relationships, or combinations thereof.

12. The method of claim 9, wherein:
the first set of selectable options comprises options related to defined user roles configured at the issue tracking platform; and
the second set of selectable options comprises options related to project type classifiers configured at the issue tracking platform.

13. The method of claim 12, wherein:
in response to detecting a selection of the second selectable option from the second set of selectable options causing the intake interface to display a text-based input field;
in response to receiving text input to the text-based input field, generating a second prompt for submission to a generative output engine using the text input; and
the structured search request is generated using a second generative response from the generative output engine received in response to submission of the second prompt to the generative output engine.

14. The method of claim 9, further comprising:
in response to detecting a selection of the second selectable option from the second set of selectable options:
generating a second prompt for submission to the generative output engine using the first selectable option and the second selectable option;
causing display, in the intake interface, of a user prompt and a text-based input field, the user prompt generated using a second generative response from the generative output engine; and
the structured search request is generated using a user input to the text-based input field.

15. The method of claim 9, wherein the formatting command comprises instructions to generate at least a portion of the generative response as a structured data format.

16. An issue tracking platform backend application operating on one or more servers, the issue tracking platform backend application operably coupled to a frontend application operating on a client device, the issue tracking platform backend application configured to:
in response to a request from a client device, generate a user account at the issue tracking platform backend application;
in response to generating the user account, cause display of an intake interface on the client device;
in response to receiving user input at the intake interface, analyze the user input to determine a project type classifier;
execute a search at the issue tracking platform backend application to identify a set of issues managed by the issue tracking platform backend application, the search comprising search parameters generated using data extracted from analyzing the user input;
cause generation of a prompt comprising:
predetermined prompt language selected based on the project type classifier; and
data extracted from the set of issues;
in response to receiving a generative response form a generative output engine, analyze the generative response to identify a first portion of data corresponding to a project definition and a second portion of data corresponding to one or more issues;
generate a project comprising the one or more issues hierarchically arranged with respect to the project; and
cause display of a project interface comprising one or more graphical objects each corresponding to an issue of the one or more issues.

17. The issue tracking platform backend application of claim 16, wherein:
the intake interface comprises a text-based input field;
in response to receiving text input to the text-based input field, generating a second prompt for submission to the generative output engine using the text input; and
update the intake interface using a generative response returned in response to providing the second prompt to the generative output engine.

18. The issue tracking platform backend application of claim 17, wherein the search at the issue tracking platform backend application is generated using a second generative response from the generative output engine received in response to providing the second prompt to the generative output engine.

19. The issue tracking platform backend application of claim 16, wherein the predetermined prompt language comprises instructions to generate at least a portion of the generative response as a structured data format.

20. The issue tracking platform backend application of claim 19, wherein analyzing the generative response comprises identifying the one or more issues and corresponding issue data from the structured data format.
